(19) United States
(12) Patent Application Publication
(10) Pub. No.: US 2015/0355450 A1
(43) Pub. Date: Dec. 10, 2015

(54) OBSERVATION DEVICE, SIGNAL OUTPUT METHOD AND COMPUTER READABLE RECORDING MEDIUM

(71) Applicant: PANASONIC HEALTHCARE HOLDINGS CO., LTD., Tokyo (JP)

(72) Inventor: Akira SAKAGUCHI, Gunma (JP)

(73) Assignee: PANASONIC HEALTHCARE HOLDINGS CO., LTD., Tokyo (JP)

(21) Appl. No.: 14/760,991

(22) PCT Filed: Feb. 14, 2014
(86) PCT No.: PCT/JP2014/000779

§ 371 Date: Jul. 14, 2015

(30) Foreign Application Priority Data
Mar. 26, 2013 (JP) 2013-063789

(51) Int. Cl. G02B 21/18; G02B 21/36; G02B 21/26; G02B 21/02; G02B 21/06

(52) U.S. Cl. CPC G02B 21/18; G02B 21/025; G02B 21/06; G02B 21/26; G02B 21/368

(57) ABSTRACT

The present application provides an optical observation device having a first optical axis and a second optical axis different in direction from the first optical axis, the observation device including a splitter configured to split image light into first light along the first optical axis and second light along the second optical axis, the image light representing an image of an observation target; and a magnifier configured to change optical magnification for at least one of a first image represented by the first light and a second image represented by the second light. The splitter includes a first area, which receives the image light, and a second area, which receives the image light next to the first area. The first and second areas allow partial passage of the image light to generate the first light. The first area partially reflects the image light to generate the second light.

### TECHNICAL FIELD

The present invention relates to techniques used for observing targets.

### BACKGROUND ART

Various observation devices have been developed to enlarge an image of a target with optical elements such as lenses. The observation devices are suitably used for cultivation of cells and inspection for electronic components.

Patent Document 1 discloses an observation device including an objective lens and a plurality of imaging devices. The observation device splits an optical path extending from the objective lens into a plurality of optical paths. Each of the imaging devices is situated in correspondence to each of the split optical paths. The observation device applies digital processes to an image obtained by each of the imaging devices to generate a plurality of enlarged images different in magnification.

Since the techniques of Patent Document 1 use the digital processing techniques to generate an enlarged image, a contour becomes zigzag. Consequently, the enlarged image obtained by the techniques of Patent Document 1 becomes inferior in sharpness to an optically enlarged image.

Patent Document 2 discloses an observation device including a macro optical system and a micro optical system. According to Patent Document 2, the macro optical system is used for observing an entire container for storing cells. The micro optical system is used for observing cells stored in the container.

The macro optical system of the observation device of Patent Document 2 is constructed on an optical axis different in position from the micro optical system. Therefore, an image obtained from the macro optical system is different in position from an image obtained from the micro optical system. When an observer uses the macro optical system to observe an image, a cell specimen as an observation target is aligned to an optical axis in correspondence to the macro optical system. When the observer then tries to obtain an image with the micro optical system, the observer has to move the cell specimen to a place on the optical axis in correspondence to the micro optical system. Consequently, the observer may not adjust magnification in a wide magnification range while observing a specific cell specimen.

As another observation technique for observing cells, there has been a device configured to divide an area, in which cells are stored, into a lot of divisional areas to obtain an image of each of the divisional areas in advance. For instance, one divisional area is sized in several mm by several mm. The device requires several hundreds of repetitions of stage movements and imaging operations for imaging an area in which cells are stored or an entire target specimen. In addition, the device requires a prolonged time of an image synthesis process in a computer. Therefore, the device is suitable for cells fixed on a slide glass but unsuitable for such objectives as quick inspection for living cells in a culture vessel since the device requires an excessively prolonged time.

Patent Document 1: JP 2008-519499 A

Patent Document 2: JP 2010-32622 A

### SUMMARY OF INVENTION

The present invention aims at providing techniques for allowing adjustment to magnification over a wide range and observation of an observation target with a clear enlarged image.

An observation device according to one aspect of the present invention has a first optical axis and a second optical axis different in direction from the first optical axis. The observation device includes a splitter configured to split image light into first light along the first optical axis and second light along the second optical axis, the image light representing an image of an observation target; a magnifier configured to change an optical magnification for at least one of a first image represented by the first light and a second image represented by the second light. The splitter includes a first area, which receives the image light, and a second area, which receives the image light next to the first area. The first and second areas allow partial passage of the image light to generate the first light. The first area partially reflects the image light to generate the second light.

A signal output method according to another aspect of the present invention is used for selectively outputting a first output signal, which represents a first image represented by first light propagating along a first optical axis, and a second output signal, which represents a second image represented by second light propagating along a second optical axis different in direction from the first optical axis, as an output signal. The signal output method includes a step of switching an output of the output signal between the first and second output signals in response to a difference between first optical magnification for the first image and second optical magnification for the second image.

A signal generation program according to another aspect of the present invention causes an output signal generator to selectively generate a first output signal, which represents a first image represented by first light propagating along a first optical axis, and a second output signal, which represents a second image represented by second light propagating along a second optical axis different in direction from the first optical axis, as an output signal. The signal generation program causes the output signal generator to execute a step of switching generation of the output signal between the first and second output signals in response to a difference between first optical magnification for the first image and second optical magnification for the second image.

The aforementioned observation device, signal output method and signal generation program allow an observer to adjust magnification over a wide range. In addition, the observer may observe an observation target by using a clear enlarged image.

Objectives, features, and advantages of the present invention will be more apparent by the following detailed description and attached drawings.

### BRIEF DESCRIPTION OF DRAWINGS

FIG. 1 is a schematic block diagram showing a functional configuration of an observation device according to the first embodiment.

FIG. 2 is a schematic flow chart showing a change operation for optical magnification by the observation device depicted in FIG. 1.

FIG. 3 is a schematic perspective view of an exemplary beam splitter used as a splitter of the observation device shown in FIG. 1.

FIG. 4 is a schematic side view of a first block of the beam splitter shown in FIG. 3.

FIG. 5 is a schematic side view of a second block of the beam splitter shown in FIG. 3.

FIG. 6 is a schematic side view of the beam splitter shown in FIG. 3.

FIG. 7 is a schematic view of a power arrangement of a first lens mechanism and a second lens mechanism of the observation device shown in FIG. 1.

FIG. 8 is a schematic view of a power arrangement of the first and second lens mechanisms of the observation device shown in FIG. 1.

FIG. 9 is a schematic view of a power arrangement of the first and second lens mechanisms of the observation device shown in FIG. 1.

FIG. 10 is a schematic view of a power arrangement of the first and second lens mechanisms of the observation device shown in FIG. 1.

FIG. 11 is a schematic view of a power arrangement of the first and second lens mechanisms of the observation device shown in FIG. 1.

FIG. 12 is a schematic view of a power arrangement of the first and second lens mechanisms of the observation device shown in FIG. 1.

FIG. 13 is a schematic block diagram showing a hardware configuration of an observation device according to the second embodiment.

FIG. 14 is a schematic view of a first lens barrel of the observation device shown in FIG. 13.

FIG. 15 is a schematic view showing operation of the first lens barrel depicted in FIG. 14.

FIG. 16 is lens data of the first lens barrel shown in FIG. 15.

FIG. 17 is a schematic view of a second lens barrel of the observation device shown in FIG. 13.

FIG. 18 is a schematic view showing operation of the second lens barrel depicted in FIG. 17.

FIG. 19 is lens data of the second lens barrel shown in FIG. 18.

FIG. 20 is a schematic perspective view of a stage of the observation device shown in FIG. 13.

FIG. 21 is a schematic cross-sectional view of the stage along a second optical axis shown in FIG. 20.

FIG. 22 is a schematic front view of a display device of the observation device shown in FIG. 13.

FIG. 23 is a schematic front view of the display device of the observation device shown in FIG. 13.

FIG. 24 is a schematic front view of the display device of the observation device shown in FIG. 13.

FIG. 25 is a schematic front view of the display device of the observation device shown in FIG. 13.

### DESCRIPTION OF EMBODIMENTS

Exemplary observation devices will be described below with reference to the attached drawings. With regard to the following embodiments, the same reference numerals are assigned to the same constituent elements. Redundant descriptions are omitted as appropriate for clarification of the description. Configurations, arrangements and shapes shown in drawings and descriptions about the drawings simply aim at making the principles of the present embodiments easily understood. Therefore, the principles of the present embodiments are not limited to these at all.

### First Embodiment

### Primary Principle

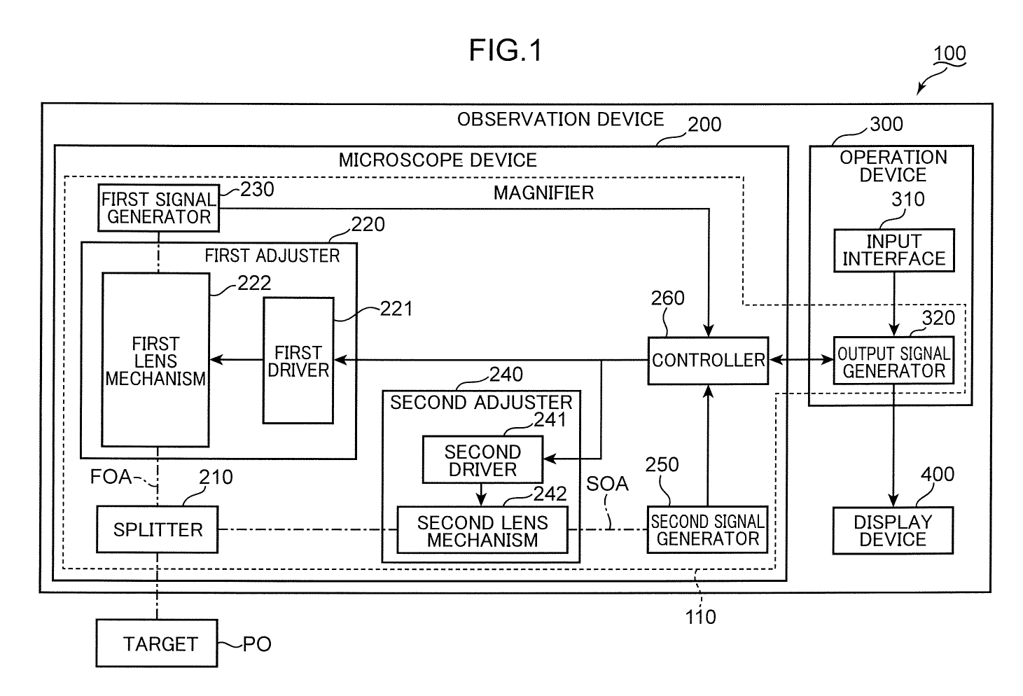

FIG. 1 is a schematic block diagram showing a functional configuration of an observation device 100 according to the first embodiment. The primary principles of various techniques which allow a user to easily observe an object is described on the basis of the observation device 100 shown in FIG. 1.

The observation device 100 is used for observing various observation targets (hereinafter, referred to as “target object PO”). The target object PO may be exemplified by various microbodies such as cells (e.g. iPS cells) and electronic components. The principles of the present embodiment are not limited by a type of the observation target at all.

The observation device 100 includes a microscope device 200, an operation device 300 and a display device 400. An observer may operate the operation device 300 to actuate the microscope device 200. The observer may observe an image of the target object PO displayed on the display device 400. The operation device 300 may be a personal computer or another computer device. The display device 400 may be a monitor device used with a computer device such as a personal computer. The display device 400 may be integrated with the operation device 300. In this case, a laptop computer or a tablet terminal may be used as the operation device 300.

The operation device 300 includes an input interface 310 and an output signal generator 320. An observer may operate the input interface 310 to input a variety of information for actuating the microscope device 200.

For instance, the observer may operate the input interface 310 to input magnification information about magnification of an image displayed on the display device 400. The output signal generator 320 generates a signal which represents magnification information. The microscope device 200 adjusts optical magnification in response to the signal which represents the magnification information. The microscope device 200 captures the target object PO at adjusted optical magnification, so that an image signal representing an image of the target object PO is then output from the microscope device 200 to the output signal generator 320. The image signal is then output from the output signal generator 320 to the display device 400. The display device 400 may display an image in correspondence to the image signal.

Alternatively, the observer may operate the input interface 310 to input positional information about a position of an image of the target object PO displayed on the display device 400. The output signal generator 320 generates a signal which represents the positional information. The microscope device 200 may move the target object PO in response to the signal which represents the positional information. In order to move the target object PO, the microscope device 200 may include a stage (not shown) used for a known microscope or another appropriate structure. The microscope device 200 captures the moved target object PO, so that an image signal representing an image of the target object PO is then output from the microscope device to the output signal generator 320. The image signal is then output from the output signal generator 320 to the display device 400. The display device 400 may display an image in correspondence to the image signal.

An input device (e.g. a keyboard or a mouse device) included in a general computer device or a touch panel used for a general tablet terminal is exemplified as the input interface 310 for receiving an input of the aforementioned request from an observer. A type of a device used as the input interface 310 does not limit the principles of the present embodiment at all. In addition, the observation device 100 may be designed so as to allow a request from an observer about other operations. A type of operational requests allowed to an observer by the observation device 100 does not limit the principles of the present embodiment at all.

The microscope device 200 includes a splitter 210, a first adjuster 220, a first signal generator 230, a second adjuster 240, a second signal generator 250 and a controller 260. As described above, the signal representing the magnification information is input from the output signal generator 320 to the controller 260 when an observer inputs magnification information to the input interface 310. The controller 260 controls at least one of the first and second adjusters 220, 240 in response to the signal representing the magnification information.

The first and/or second adjusters 220, 240 adjust optical magnification for an image representing the target object PO under control of the controller 260. The first signal generator 230 captures the target object PO at optical magnification adjusted by the first adjuster 220. Image data of the captured target object PO is then output from the first signal generator 230 to the controller 260. The second signal generator 250 captures the target object PO at optical magnification adjusted by the second adjuster 240. Image data of the imaged target object PO is then output from the second signal generator 250 to the controller 260. Image data from the first and/or second signal generators 230, 250 is output from the controller 260 to the output signal generator 320. The output signal generator 320 outputs the image data from the controller 260 to the display device 400 as an image signal. Consequently, an observer may observe an image of the target object PO displayed on the display device 400.

In the present embodiment, the splitter 210, the first adjuster 220, the first signal generator 230, the second adjuster 240, the second signal generator 250 and the controller 260 of the microscope device 200 and the output signal generator 320 of the operation device 300 are used as a magnifier 110 for changing optical magnification for an image of the target object PO. The output signal generator may be an element integrated into the microscope device. Alternatively, the controller may be an element integrated into the operation device.

The microscope device 200 has a first optical axis FOA and a second optical axis SOA orthogonal to the first optical axis FOA. The splitter 210 is designed so as to define the first and second optical axes FOA, SOA. The second optical axis SOA may not be strictly orthogonal to the first optical axis FOA. When the principle of the present embodiment is materialized, an angular difference between extension directions of the first and second optical axes FOA, SOA may be set smaller or larger than 90°.

Image light representing the target object PO propagates along the first optical axis FOA, and then reaches the splitter 210. The splitter 210 partially transmits the image light to generate first light propagating along the first optical axis FOA. At the same time, the splitter 210 partially reflects the image light to generate second light propagating along the second optical axis SOA. In short, the splitter 210 splits the image light representing the target object PO into the first light and the second light. In the following description, the image of the target object PO represented by the first light is referred to as “first image” whereas the image of the target object PO represented by the second light is referred to as “second image”.

The first adjuster 220 includes a first driver 221 and a first lens mechanism 222. The first driver 221 drives the first lens mechanism 222 under control of the controller 260. The first light enters the first lens mechanism 222 from the splitter 210. The first lens mechanism 222 situated on the first optical axis FOA adjusts optical magnification for the first image in response to the magnification information, which has been input through the input interface 310. In the following description, the optical magnification for the first image defined by the first lens mechanism 222 is referred to as “first optical magnification”. In the present embodiment, a setting range of the first optical magnification is equal to or more than ⅙ times (⅙×) and equal to or less than 1 time (1×). The setting range of the first optical magnification does not limit the principles of the present embodiment at all. The setting range of the first optical magnification may be appropriately set for an application of an observation device.

The first signal generator 230 receives the first light passing through the first lens mechanism 222. Since the first lens mechanism 222 sets the optical magnification for the first image at the first optical magnification as described above, the first signal generator 230 generates image data of the first image at the first optical magnification. Various known imaging devices may be used as the first signal generator 230. For instance, a CCD camera or a CMOS camera may be used as the first signal generator 230. The first signal generator 230 outputs the image data of the first image as an electric signal to the controller 260. The first signal is exemplified by the electric signal output from the first signal generator 230 to the controller 260.

The second adjuster 240 includes a second driver 241 and a second lens mechanism 242. The second driver 241 drives the second lens mechanism 242 under control of the controller 260. The second light enters the second lens mechanism 242 from the splitter 210. The second lens mechanism 242 situated on the second optical axis SOA adjusts optical magnification for the second image information in response to the magnification which has been input through the input interface 310. In the following description, the optical magnification for the second image defined by the second lens mechanism 242 is referred to as “second optical magnification”. In the present embodiment, a setting range of the second optical magnification is equal to or more than 1 time (1×) and equal to or less than 4 times (4×). The setting range of the second optical magnification does not limit the principles of the present embodiment at all. The setting range of the second optical magnification may be appropriately set for an application of an observation device.

The second signal generator 250 receives the second light passing through the second lens mechanism 242. Since the second lens mechanism 242 sets the optical magnification for the second image at the second optical magnification as described above, the second signal generator 250 generates image data of the second image of the second optical magnification. Various known imaging devices may be used as the second signal generator 250. For instance, a CCD camera or a CMOS camera may be used as the second signal generator 250. The second signal generator 250 outputs the image data of the second image as an electric signal to the controller 260. The second signal is exemplified by the electric signal output from the second signal generator 250 to the controller 260.

In the present embodiment, an observer may operate the input interface 310 to give the observation device 100 a request of the optical magnification of “⅙×”. The magnification information requesting the optical magnification of “⅙×” is then output from the output signal generator 320 to the controller 260.

The controller 260 controls the first adjuster 220 in response to the magnification information from the output signal generator 320. The first driver 221 drives the first lens mechanism 222 under control of the controller 260 to set the first optical magnification at “⅙×”. Meanwhile, the controller 260 may also control the second adjuster 240. The second driver 241 may drive the second lens mechanism 242 under control of the controller 260 to set the second optical magnification at “1×”.

When the first optical magnification is set at “⅙×”, the controller 260 receives an electric signal from the first signal generator 230 whereas the controller may shut off a path of an electric signal from the second signal generator 250. Alternatively, when the first optical magnification is set at “⅙×”, the controller 260 may receive both electric signals from the first and second signal generators 230, 250. In this case, only image data in response to the electric signal from the first signal generator 230 may be output from the controller 260 to the output signal generator 320. Further alternatively, when the first optical magnification is set at “⅙×”, image data in response to the electric signal from the first and second signal generators 230, 250 may be output from the controller 260 to the output signal generator 320. In this case, the controller 260 may give an instruction to the output signal generator 320 for generating an output signal on the basis of only image data from the first signal generator 230. Other control may be performed among the first signal generator 230, the second signal generator 250, the controller 260 and the output signal generator 320 when the output signal generator 320 generates a signal representing the first image under the first optical magnification set at “⅙×”.

When the first optical magnification is set at “⅙×”, the output signal generator 320 generates an image signal in correspondence to the image data output by the first signal generator 230. The image signal is then output from the output signal generator 320 to the display device 400. In the following description, the process for generating an image signal in correspondence to the image data output by the first signal generator 230 is referred to as “first generation process”. The first output signal is exemplified by the image signal which is generated by the first generation process.

When the first optical magnification is set at “⅙×”, the display device 400 displays a wide range of the target object PO. Therefore, an observer may observe the target object PO over a wide range. When the observer finds out a specific part to be observed in detail in the target object PO, the observer may operate the input interface 310 to input positional information so that the specific part is displayed at the center of a screen of the display device 400. The observation device 100 may move the target object PO in response to the positional information to position the specific part at the center of the screen.

The observer may then operate the input interface 310 to input optical magnification of “4×”. Magnification information representing the optical magnification of “4×” is output from the output signal generator 320 to the controller 260.

The controller 260 controls the first adjuster 220 in response to the magnification information from the output signal generator 320. The first driver 221 drives the first lens mechanism 222 under control of the controller 260 to gradually change the first optical magnification from “⅙×” to “1×”. While the first optical magnification is changed from “⅙×” to “1×”, the output signal generator 320 continues the first generation process. Therefore, the display device 400 displays the first image which changes from “⅙×” to “1×”.

The controller 260 stops the control for the first adjuster 220 and starts controlling the second adjuster 240 when the first optical magnification becomes “1×”. As described above, the second optical magnification is set at “1×” at this time.

When the first optical magnification becomes “1×”, the controller 260 receiving an electric signal from the second signal generator 250 may shut off a path of an electric signal from the first signal generator 230. Alternatively, when the first optical magnification becomes “1×”, the controller 260 may receive both electric signals from the second and first signal generators 250, 230. In this case, only image data in response to the electric signal from the second signal generator 250 may be output from the controller 260 to the output signal generator 320. Further alternatively, when the first optical magnification becomes “1×”, image data in response to the electric signals from the second and first signal generators 250, 230 may be output from the controller 260 to the output signal generator 320. In this case, the controller 260 may give an instruction to the output signal generator 320 for generating an output signal on the basis of only the image data from the second signal generator 250. Other control may be performed among the second signal generator 250, the first signal generator 230, the controller 260 and the output signal generator 320 when the output signal generator 320 generates a signal representing the second image at “1×” of the first optical magnification.

The controller 260 controls the second adjuster 240 in response to the magnification information from the output signal generator 320. The second driver 241 drives the second lens mechanism 242 under control of the controller 260 to gradually change the second optical magnification from “1×” to “4×”. While the second optical magnification changes from “1×” to “4×”, the output signal generator 320 generates an image signal in correspondence to the image data output by the second signal generator 250. The image signal is then output from the output signal generator 320 to the display device 400. In the following description, the process for generating an image signal in correspondence to the image data output by the second signal generator 250 is referred to as “second generation process”. The second output signal is exemplified by the image signal which is generated by the second generation process.

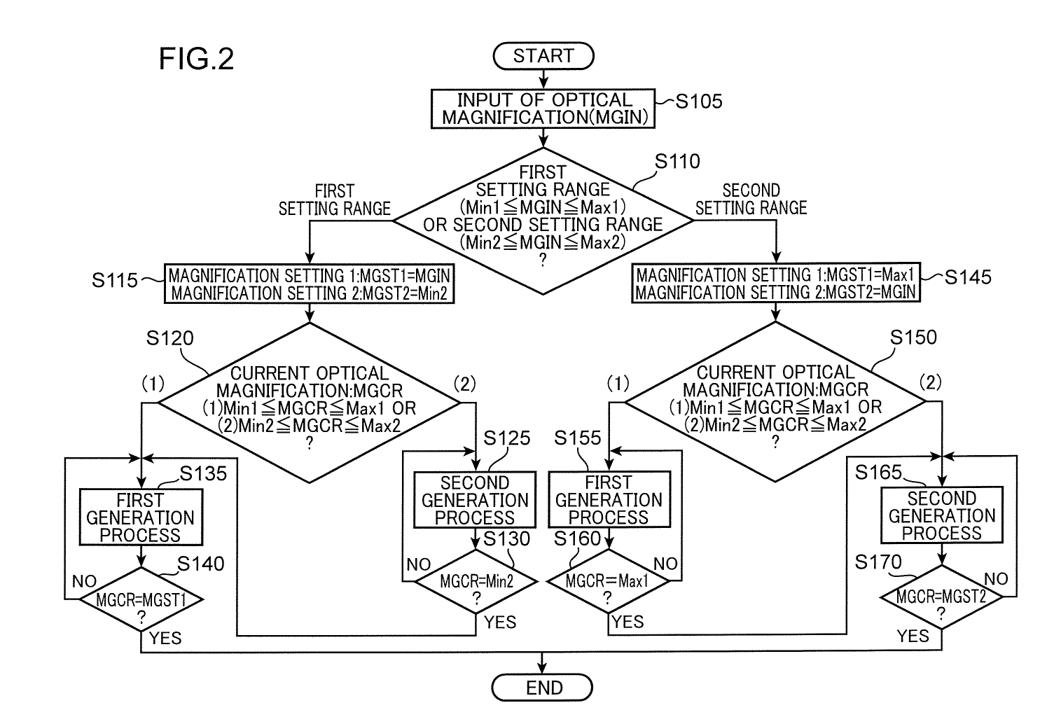

FIG. 2 is a schematic flow chart showing a change operation of optical magnification by the observation device 100. The change operation of the optical magnification is described with reference to FIGS. 1 and 2.

### (Step S105)

In step S105, an observer operates the input interface 310 to input optical magnification. Magnification information representing the optical magnification is then output from the input interface 310 to the controller 260 through the output signal generator 320. When the controller 260 receives the magnification information, step S110 is executed. In FIG. 2, the optical magnification input by the observer is represented by the symbol “MGIN”.

### (Step S110)

In step S110, the controller 260 determines whether the magnification information represents optical magnification in a first setting range or a second setting range. The first adjuster 220 adjusts optical magnification for the first image in the first setting range. The second adjuster 240 adjusts optical magnification for the second image in the second setting range.

In FIG. 2, the minimum value of the first setting range is represented by the symbol “Min1”. In the present embodiment, the minimum value “Min1” of the first setting range is set at “⅙×”.

In FIG. 2, the maximum value of the first setting range is represented by the symbol “Max1”. In the present embodiment, the maximum value “Max1” of the first setting range is set at “1×”.

In FIG. 2, the minimum value of the second setting range is represented by the symbol “Min2”. In the present embodiment, the minimum value “Min2” of the second setting range is set at “1×”.

In FIG. 2, the maximum value of the second setting range is represented by the symbol “Max2”. In the present embodiment, the maximum value “Max2” of the second setting range is set at “4×”.

When the magnification information represents the optical magnification in the first setting range, step S115 is executed. When the magnification information represents the optical magnification in the second setting range, step S145 is executed. In the present embodiment, the maximum value “Max1” of the first setting range is equal to the minimum value “Min2” of the second setting range. In this case, one of steps S115, S145 may be selectively executed.

### (Step S115)

In step S115, the controller 260 sets optical magnification “MGIN” represented by the magnification information as target optical magnification for the first adjuster 220. In addition, the controller 260 sets the minimum value “Min2” of the second setting range as target optical magnification for the second adjuster 240. In FIG. 2, the target optical magnification for the first adjuster 220 is represented by the symbol “MGST1”. The target optical magnification for the second adjuster 240 is represented by the symbol “MGST2”. When the controller 260 sets the target optical magnifications “MGST1” and “MGST2” for the first and second adjusters 220, 240, step S120 is executed.

### (Step S120)

In step S120, the controller 260 verifies current optical magnification. In FIG. 2, the current optical magnification is represented by the symbol “MGCR”. When the current optical magnification “MGCR” is in the first setting range, step S135 is executed. When the current optical magnification “MGCR” is in the second setting range, step S125 is executed. In the present embodiment, the maximum value “Max1” of the first setting range is equal to the minimum value “Min2” of the second setting range. In this case, step S135 may be preferentially executed.

### (Step S125)

In step S125, unless the current optical magnification “MGCR” is equal to the minimum value “Min2” in the second setting range, the controller 260 controls the second adjuster 240 to change the second optical magnification toward the minimum value “Min2” of the second setting range. Otherwise, step S130 is executed. During step S125, the output signal generator 320 performs the second generation process. Therefore, the display device 400 displays the second image. Step S130 is then executed.

### (Step S130)

In step S130, the controller 260 determines whether the second optical magnification is equal to the minimum value “Min2” of the second setting range. When the second optical magnification is equal to the minimum value “Min2” of the second setting range, step S135 is executed. Otherwise, step S125 is executed.

### (Step S135)

In step S135, the controller 260 controls the first adjuster 220 to change the first optical magnification toward the optical magnification “MGIN” represented by the magnification information. Step S140 is then executed.

### (Step S140)

In step S140, the controller 260 determines whether the first optical magnification is equal to the optical magnification “MGIN” represented by the magnification information. When the first optical magnification is equal to the optical magnification “MGIN” represented by the magnification information, the optical magnification adjustment is ended. Otherwise, step S135 is executed.

### (Step S145)

In step S145, the controller 260 sets the optical magnification “MGIN” represented by the magnification information as target optical magnification for the second adjuster 240. In addition, the controller 260 sets the maximum value “Max1” of the first setting range as target optical magnification for the first adjuster 220. In FIG. 2, the target optical magnification for the second adjuster 240 is represented by the symbol “MGST2”. The target optical magnification for the first adjuster 220 is represented by the symbol “MGST1”. When the controller 260 sets the target optical magnifications “MGST2” and “MGST1” for the second and first adjusters 240, 220, step S150 is executed.

### (Step S150)

In step S150, the controller 260 verifies the current optical magnification “MGCR”. When the current optical magnification “MGCR” is in the second setting range, step S165 is executed. When the current optical magnification “MGCR” is in the first setting range, step S155 is executed. In the present embodiment, the minimum value “Min2” of the second setting range is equal to the maximum value “Max1” of the first setting range. In this case, step S165 may be preferentially executed.

### (Step S155)

In step S155, unless the current optical magnification “MGCR” is equal to the maximum value “Max1” of the first setting range, the controller 260 controls the first adjuster 220 to change the first optical magnification toward the maximum value “Max1” of the first setting range. Otherwise, step S160 is executed. During step S155, the output signal generator 320 performs the first generation process. Therefore, the display device 400 displays the first image. Step S160 is then executed.

### (Step S160)

In step S160, the controller 260 determines whether the first optical magnification is equal to the maximum value “Max1” of the first setting range. When the first optical magnification is equal to the maximum value “Max1” of the first setting range, step S165 is executed. Otherwise, step S155 is executed.

### (Step S165)

In step S165, the controller 260 controls the second adjuster 240 to change the second optical magnification toward the optical magnification “MGIN” represented by the magnification information. Step S170 is then executed.

### (Step S170)

In step S170, the controller 260 determines whether the second optical magnification is equal to the optical magnification “MGIN” represented by the magnification information. When the second optical magnification is equal to the optical magnification “MGIN” represented by the magnification information, the optical magnification adjustment is ended. Otherwise, step S165 is executed.

The following condition 1 or 2 is achieved by the processes in steps S115, S145.

### (Condition 1)

The first optical magnification is equal to the maximum value of the first setting range.

### (Condition 2)

The second optical magnification is equal to the minimum value of the second setting range.

In the present embodiment, generation process of the output signal by the output signal generator 320 is switched between the first and second generation processes when a difference between the first optical magnification and the second optical magnification becomes “0” since the maximum value of the first setting range is equal to the minimum value of the second setting range. Alternatively, generation process of the output signal may be switched between the first and second generation processes when a difference between the first optical magnification and the second optical magnification becomes a predetermined value (>0). When a threshold value set for the difference between the first optical magnification and the second optical magnification is sufficiently small, the switchover of the generation process of the output signal between the first and second generation processes becomes less influential to an image observed by the observer. Therefore, the maximum value of the first setting range may not be equal to the minimum value of the second setting range.

The switchover of the generation process of the output signal between the first and second generation processes may be achieved by a program which is executed by the controller 260.

### (Splitter)

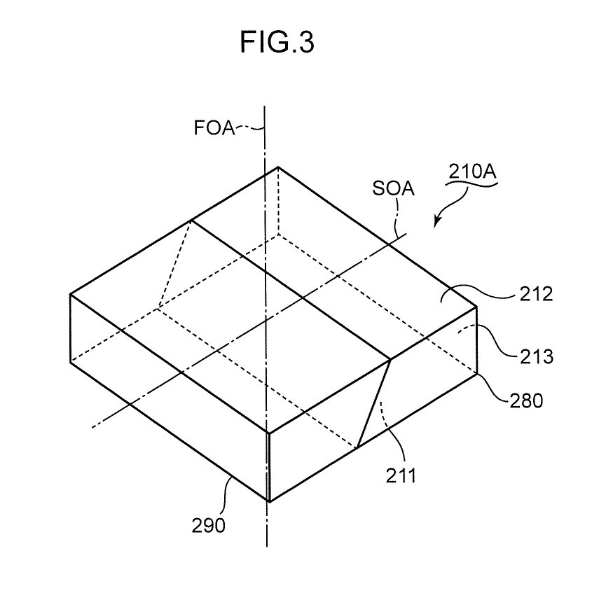

FIG. 3 is a schematic perspective view of an exemplary beam splitter 210A used as the splitter 210. The beam splitter 210A is described with reference to FIGS. 1 and 3.

The beam splitter 210A includes a substantially flat incident end surface 211, on which image light of the target object PO is incident, a substantially flat first emission end surface 212, from which the first light emits, and a substantially flat second emission end surface 213, from which the second light emits. Both of the incident end surface 211 and the first emission end surface 212 are substantially orthogonal to the first optical axis FOA. The second emission end surface 213 is substantially orthogonal to the second optical axis SOA.

The beam splitter 210A includes a first block 280 and a second block 290. Each of the first and second blocks 280, 290 includes a substantially rectangular trapezoidal side surface. In addition, the first and second blocks 280, 290 are formed from materials having substantially the same refractive indices. Refractive indices of the first and second blocks 280, 290 are not limited as long as they are higher than a refractive index of the air. In the present embodiment, the first and second blocks 280, 290 are formed from glass having refractive index of “1.5”.

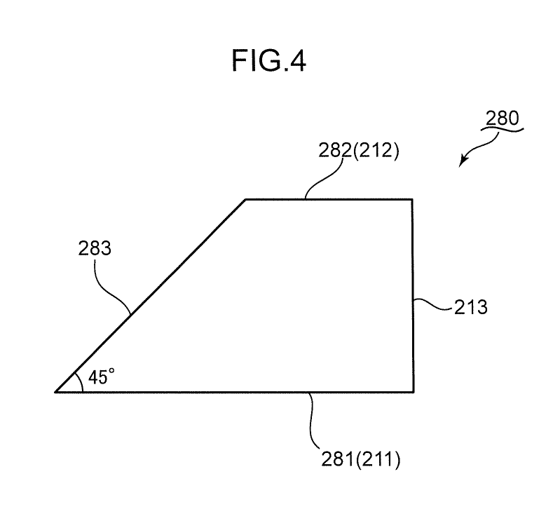

FIG. 4 is a schematic side view of the first block 280. The first block 280 is described with reference to FIG. 4.

The first block 280 includes the second emission end surface 213. The first block 280 further includes a first broad surface 281, which forms a part of the incident end surface 211, and a first narrow surface 282, which forms a part of the first emission end surface 212. The first block 280 further includes a first inclined surface 283 opposite to the second emission end surface 213. The first inclined surface 283 is inclined at an angle of substantially 45° from the first broad surface 281.

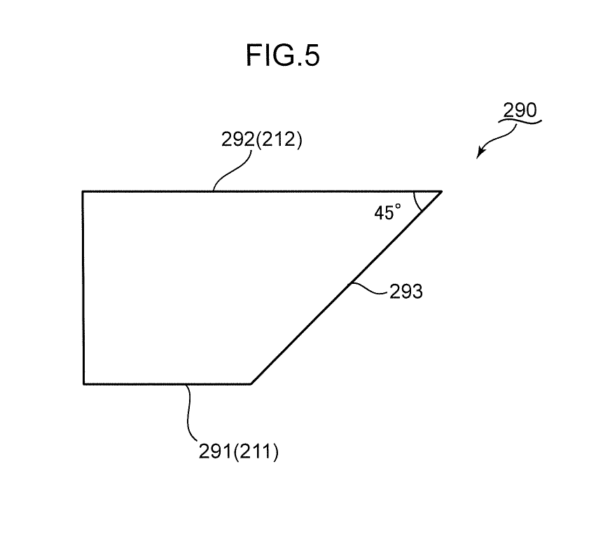

FIG. 5 is a schematic side view of the second block 290. The second block 290 is described with reference to FIG. 5.

The second block 290 further includes a second narrow surface 291, which forms a part of the incident end surface 211, and a second broad surface 292, which forms a part of the first emission end surface 212. The second block 290 further includes a second inclined surface 293 which is inclined at an angle of substantially 45° from the second broad surface 292.

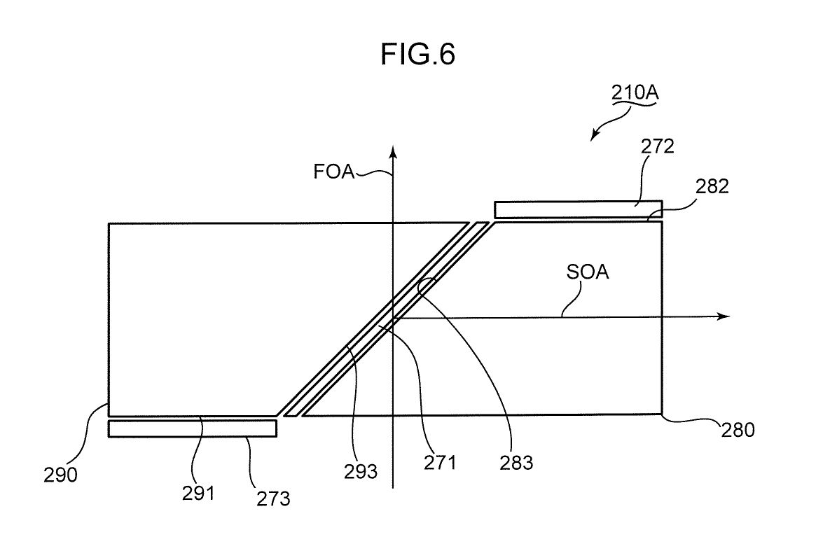

FIG. 6 is a schematic side view of the beam splitter 210A. The beam splitter 210A is described with reference to FIGS. 1 and 6.

The beam splitter 210A further includes a half mirror film 271, a first darkening film 272 and a second darkening film 273. The half mirror film 271, the first darkening film 272 and the second darkening film 273 may be formed by known film forming techniques so that each of the half mirror film 271, the first darkening film 272 and the second darkening film 273 has a thickness (several μm) which is mechanically negligible.

The half mirror film 271 is formed between the first and second inclined surfaces 283, 293. The half mirror film 271 entirely covers the first and second inclined surfaces 283, 293. The half mirror film 271 may work for bonding the first and second blocks 280, 290.

When the image light of the target object PO reaches the half mirror film 271, the half mirror film 271 allows partial passage of the image light to generate the first light propagating along the first optical axis FOA. At the same time, the half mirror film 271 partially reflects the image light to generate the second light propagating along the second optical axis SOA. In the present embodiment, the first area is exemplified by the boundary area formed by the half mirror film 271, the first inclined surface 283 and the second inclined surface 293.

For instance, the half mirror film 271 transmits 50% of the image light and reflects the remaining 50%. Consequently, a captured object is less likely to have a difference in brightness between the first and second imaging devices. However, reflectance to the imaging device side which has larger magnification may be higher so that the reflectance of the half mirror film to the second imaging device side having large magnification becomes 70% and the transmittance becomes 30% since an image of a large optical magnification becomes dark in general. At this time, transmittance of the darkening film is made to be 30%.

A formation area of the half mirror film 271 is sized so that an image of an area narrower than an area in correspondence to the formation area of the half mirror film 271 is displayed on the display device 400 when there is a switchover between the first and second generation processes. Consequently, an observer is less likely to perceive the switchover between the first and second generation processes.

The first darkening film 272 covers the first narrow surface 282. The first darkening film 272 receives the image light of the target object PO next to the half mirror film 271. The first darkening film 272 allows passage of a light quantity smaller than a light quantity of the incident image light to generate the first light propagating along the first optical axis FOA. The second darkening film 273 covers the second narrow surface 291. The second darkening film 273 receives the image light of the target object PO next to the half mirror film 271. The second darkening film 273 allows transmission of a light quantity smaller than a light quantity of the incident image light to generate the first light propagating along the first optical axis FOA. The second area is exemplified by the formation areas of the first and second darkening films 272, 273.

There is a decrease in brightness difference between an area of the first image in correspondence to the formation area of the half mirror film 271 and an area of the first image in correspondence to the formation area of the first and second darkening films 272, 273 since the first and second darkening films 272, 273 reduce a light quantity. Ideally, the first and second darkening films 272, 273 also allow the transmission of 50% of the light quantity when the half mirror film 271 allows the transmission of 50% of the light quantity. It is not necessary that the half mirror film 271, the first darkening film 272 and the second darkening film 273 have the same light transmittance. The light transmittance of the half mirror film 271, the first darkening film 272 and the second darkening film 273 may be set so that a brightness difference in the first image is sufficiently reduced.

The beam splitter 210A is incorporated in the microscope device 200 so that the first optical axis FOA extends through substantially the center of the area of the half mirror film 271 formed between the first and second darkening films 272, 273.

### (Lens Mechanism Operation)

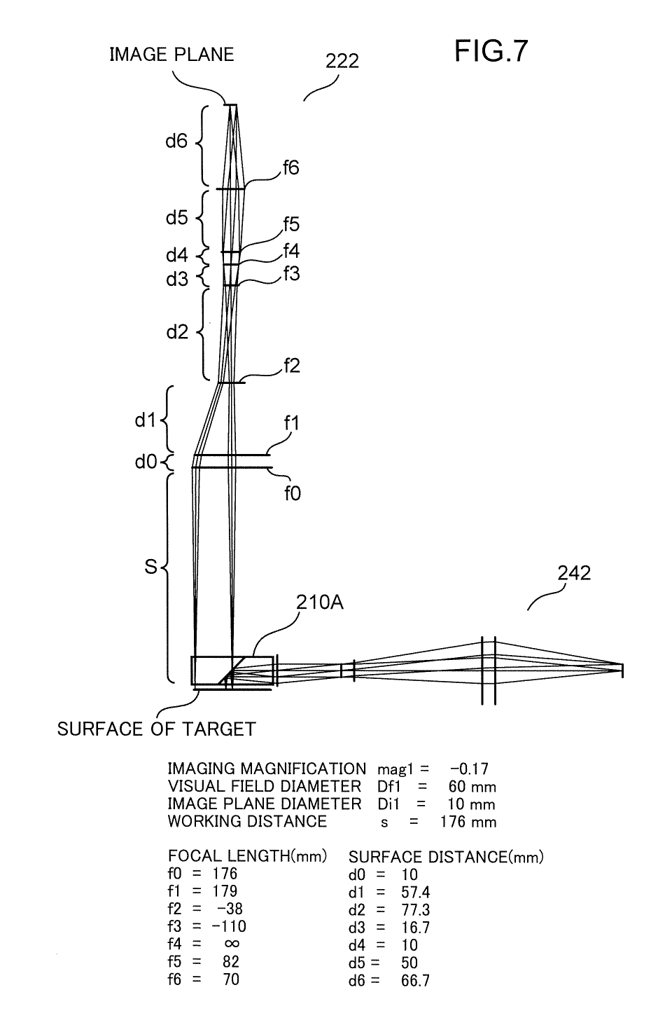

FIG. 7 is a schematic view of a power arrangement of the first and second lens mechanisms 222, 242. Operation of the first lens mechanism 222 is described with reference to FIGS. 1 and 7.

Optical magnification of the first lens mechanism 222 of FIG. 7 is set at “0.17×”. In addition, a visual field diameter of the first lens mechanism 222 is set at “60 mm”. Furthermore, an image plane diameter of the first lens mechanism 222 is set at “10 mm”. The first driver 221 drives the first lens mechanism 222 so as to maintain the image plane diameter.

The symbol “f0” shown in FIG. 7 may be a close-up lens. The symbol “f1” shown in FIG. 7 may be a focusing lens. The symbol “f2” shown in FIG. 7 may be a variator. The symbol “f3” shown in FIG. 7 may be a compensator. The symbol “f4” shown in FIG. 7 may be a diaphragm. The symbols “f5” and “f6” shown in FIG. 7 may be relay lenses.

The focal length of the close-up lens “f0” is “176 mm”. The focal length of the focusing lens “f1” is “179 mm”. The focal length of the variator “f2” is “−38 mm”. The focal length of the compensator “f3” is “−110 mm”. The focal length of the relay lens “f5” is “82 mm”. The focal length of the relay lens “f6” is “70 mm”.

The working distance “s” from a surface of the target object PO to the close-up lens “f0” is set at “176 mm”. The distance “d0” from the close-up lens “f0” to the focusing lens “f1” is set at “10 mm”. The distance “d1” from the focusing lens “f1” to the variator “f2” is set at “57.4 mm”. The distance “d2” from the variator “f2” to the compensator “f3” is set at “77.3 mm”. The distance “d3” from the compensator “f3” to the diaphragm “f4” is set at “16.7 mm”. The distance “d4” from the diaphragm “f4” to the relay lens “f5” is set at “10 mm”. The distance “d5” from the relay lens “f5” to the relay lens “f6” is set at “50 mm”. The distance “d6” from the relay lens “f6” to the image plane of the first signal generator 230 is set at “66.7 mm”. The distances “d1”, “d2”, “d3” are changed along with a change of the optical magnification among the distance parameters. Other distance parameters “d0”, “d4”, “d5”, “d6” are constant regardless of the change of the optical magnification.

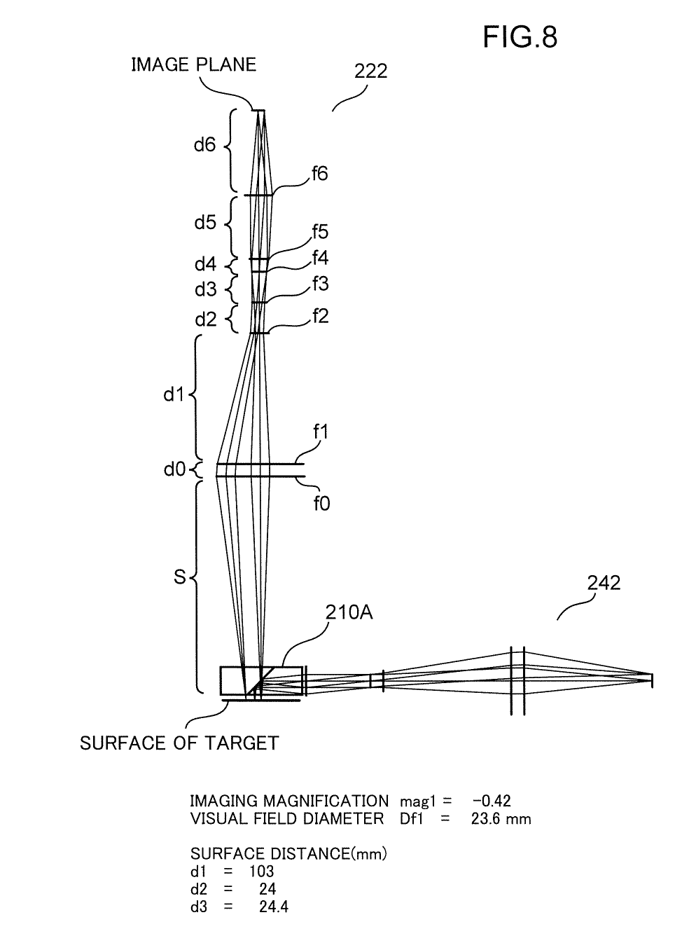

FIG. 8 is a schematic view of a power arrangement of the first and second lens mechanisms 222, 242. The operation of the first lens mechanism 222 is described with reference to FIGS. 7 and 8.

Optical magnification of the first lens mechanism 222 of FIG. 8 is set at “0.42×”. In addition, a visual field diameter of the first lens mechanism 222 is set at “23.6 mm”.

When a setting of the optical magnification is changed from “0.17×” to “0.42×”, the distance “d1” is changed from “57.4 mm” to “103 mm”. The distance “d2” is changed from “77.3 mm” to “24 mm”. The distance “d3” is changed from “16.7 mm” to “24.4 mm”.

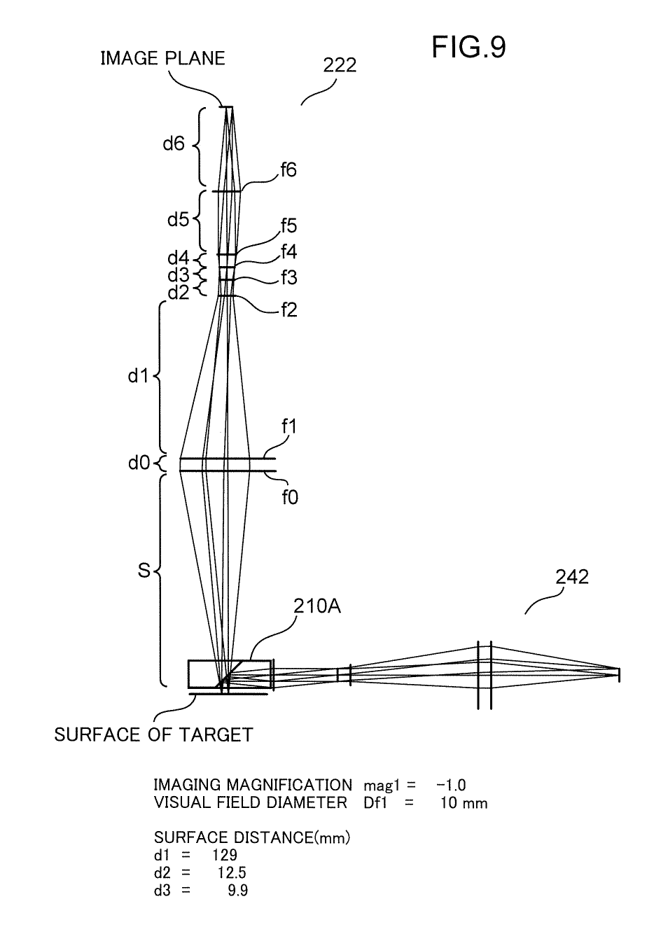

FIG. 9 is a schematic view of a power arrangement of the first and second lens mechanisms 222, 242. The operation of the first lens mechanism 222 is described with reference to FIGS. 8 and 9.

Optical magnification of the first lens mechanism 222 of FIG. 9 is set at “1×”. In addition, a visual field diameter of the first lens mechanism 222 is set at “10 mm”.

When a setting of the optical magnification is changed from “0.42×” to “1×”, the distance “d1” is changed from “103 mm” to “129 mm”. The distance “d2” is changed from “24 mm” to “12.5 mm”. The distance “d3” is changed from “24.4 mm” to “9.9 mm”.

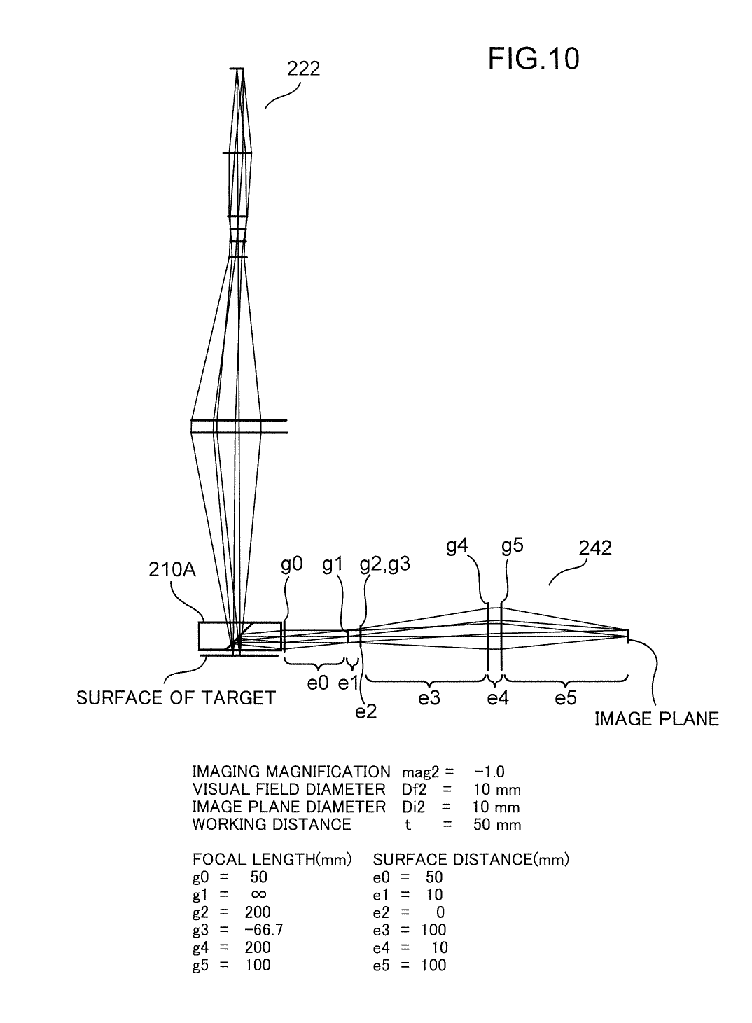

FIG. 10 is a schematic view of a power arrangement of the first and second lens mechanisms 222, 242. The operation of the second lens mechanism 242 is described with reference to FIGS. 1, 2, 7 to 10.

As described with reference to FIG. 2, while the optical magnification of the first lens mechanism 222 is changed from “0.17×” to “1×”, the optical magnification of the second lens mechanism 242 is maintained at “1×”. The optical magnification of the second lens mechanism 242 of FIG. 10 is set at “1×”. In addition, a visual field diameter of the second lens mechanism 242 is set at “10 mm”. Furthermore, an image plane diameter of the second lens mechanism 242 is set at “10 mm”. The second driver 241 drives the second lens mechanism 242 so as to maintain the image plane diameter.

The symbols “g0”, “g1” shown in FIG. 10 may be microscope objective lenses. The symbols “g2”, “g3” shown in FIG. 10 may be afocal zoom units. The symbols “g4”, “g5” shown in FIG. 10 may be imaging lenses.

The focal length of the microscope objective lens “g0” is “50 mm”. The microscope objective lens “g1” is a diaphragm plane. The focal length of the afocal zoom unit “g2” is “200 mm”. The focal length of the afocal zoom unit “g3” is “−66.7 mm”. The focal length of the afocal zoom unit “g4” is “200 mm”. The focal length of the imaging lens “g5” is “100 mm”.

The distance “e0” from the microscope objective lens “g0” to the microscope objective lens “g1” is set at “50 mm”. The distance “e1” from the microscope objective lens “g1” to the afocal zoom unit “g2” is set at “10 mm”. The distance “e2” from the afocal zoom unit “g2” to the afocal zoom unit “g3” is set at “0 mm”. The distance “e3” from the afocal zoom unit “g3” to the imaging lens “g4” is set at “100 mm”. The distance “e4” from the imaging lens “g4” to the imaging lens “g5” is set at “10 mm”. The distance “e5” from the imaging lens “g5” to the image plane of the second signal generator 250 is set at “100 mm”. The distances “e2”, “e3” are changed along with a change of the optical magnification among the distance parameters. Other distance parameters “d0”, “e1”, “e4”, “e5” are constant regardless of the change of the optical magnification.

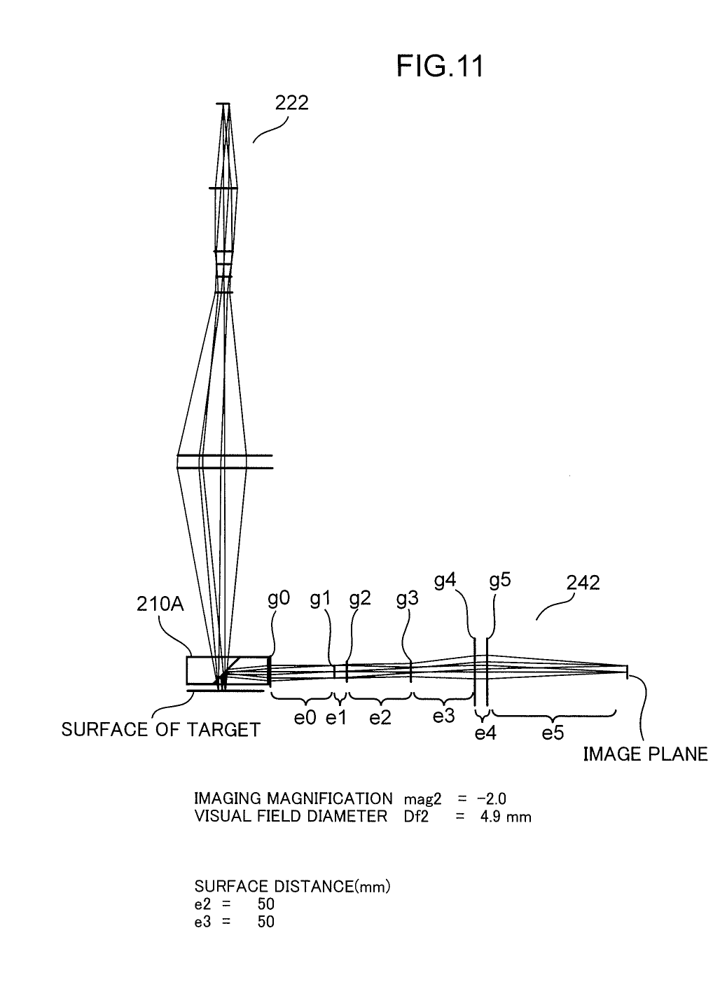

FIG. 11 is a schematic view of a power arrangement of the first and second lens mechanisms 222, 242. The operation of the first lens mechanism 222 is described with reference to FIGS. 10 and 11.

The optical magnification of the second lens mechanism 242 of FIG. 11 is set at “2.0×”. In addition, the visual field diameter of the second lens mechanism 242 is set at “4.9 mm”.

When a setting of the optical magnification is changed from “1×” to “2.0×”, the distance “e2” is changed from “0 mm” to “50 mm”. The distance “e3” is changed from “100 mm” to “50 mm”.

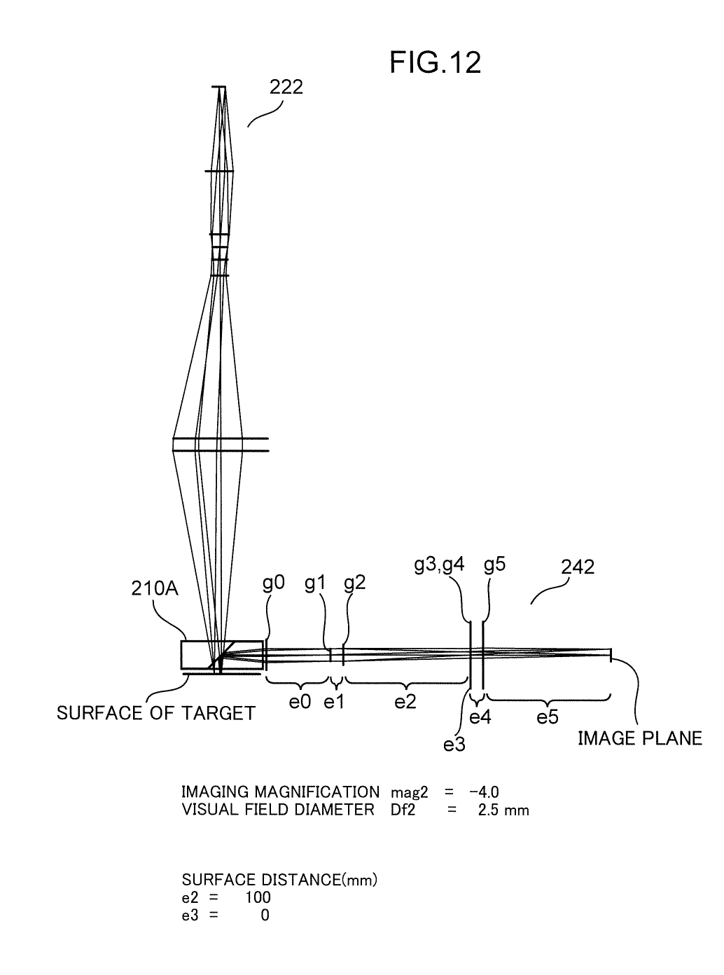

FIG. 12 is a schematic view of a power arrangement of the first and second lens mechanisms 222, 242. The operation of the first lens mechanism 222 is described with reference to FIGS. 11 and 12.

The optical magnification of the second lens mechanism 242 of FIG. 12 is set at “4.0×”. In addition, the visual field diameter of the second lens mechanism 242 is set at “2.5 mm”.

When a setting of the optical magnification is changed from “2.0×” to “4.0×”, the distance “e2” is changed from “50 mm” to “100 mm”. The distance “e3” is changed from “50 mm” to “0 mm”.

### Second Embodiment

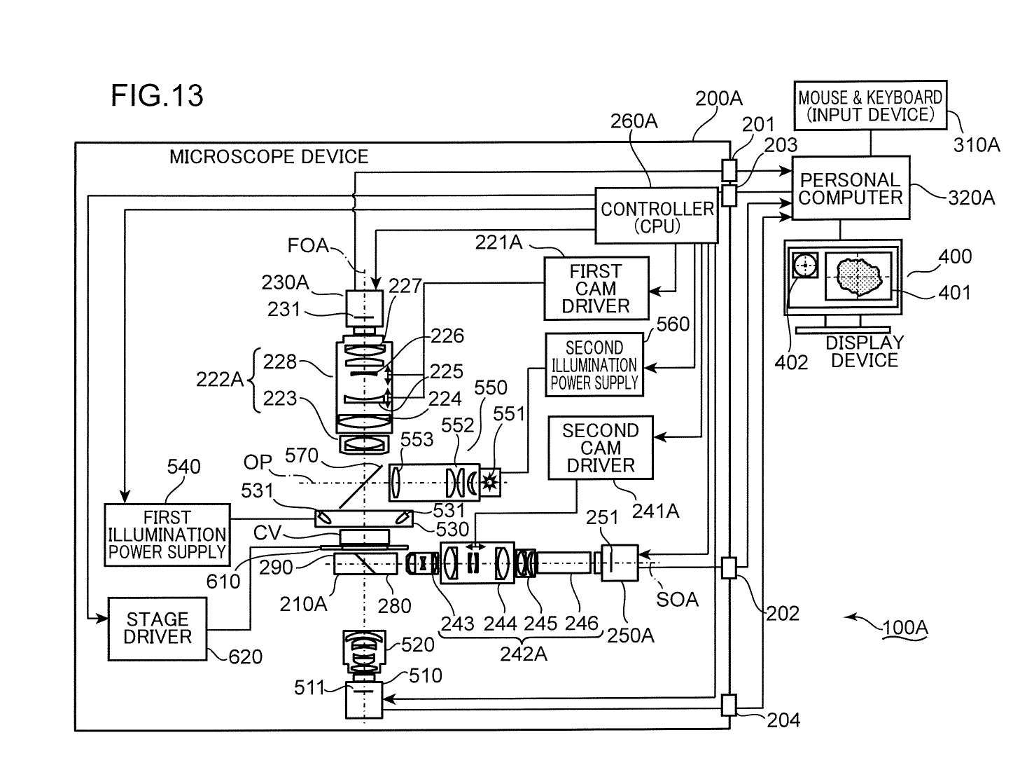

FIG. 13 is a schematic block diagram showing a hardware configuration of an observation device 100A according to the second embodiment. The observation device 100A is described with reference to FIGS. 1, 6 and 13. The observation device 100A is constructed on the basis of the principles of the first embodiment. Therefore, the same reference numerals are used for the same elements as the first embodiment. The description of the first embodiment is applicable to the elements to which the same reference numerals are assigned.

The observation device 100A includes a microscope device 200A, an input device 310A, a personal computer 320A and a display device 400. The input device 310A corresponds to the input interface 310 described in the context of the first embodiment. The personal computer 320A has a function of the output signal generator 320 described in the context of the first embodiment.

The microscope device 200A includes a beam splitter 210A, a first cam driver 221A, a first lens barrel 222A, a first CCD camera 230A, a second cam driver 241A, a second lens barrel 242A, a second CCD camera 250A and a controller 260A. The beam splitter 210A, the first lens barrel 222A and the first CCD camera 230A are aligned on the first optical axis FOA. The beam splitter 210A, the second lens barrel 242A and the second CCD camera 250A are aligned on the second optical axis SOA. The beam splitter 210A is situated so that an intersection of the first optical axis FOA with the second optical axis SOA is positioned on the boundary between the first and second blocks 280, 290.

The first lens barrel 222A includes a close-up lens 223 and a zoom lens portion 228. The zoom lens portion 228 is situated between the close-up lens 223 and the first CCD camera 230A. The close-up lens 223 is situated between the zoom lens portion 228 and the beam splitter 210A.

The zoom lens portion 228 includes a focusing lens 224, a variator 225, a compensator 226 and a relay lens 227. The first cam driver 221A uses a cam to drive the variator 225 and the compensator 226. The first lens barrel 222A corresponds to the first lens mechanism 222 described in the context of the first embodiment. The first cam driver 221A corresponds to the first driver 221 described in the context of the first embodiment.

A culture vessel CV in which cells are stored is situated between the close-up lens 223 and the beam splitter 210A. In the present embodiment, the observation target is the cells in the culture vessel CV.

The first CCD camera 230A includes a first imaging surface 231. The first cam driver 221A drives the first lens barrel 222A to make the first lens barrel 222A form an image of the cells represented by light propagating along the first optical axis FOA at a variety of magnification on the first imaging surface 231. The first imaging surface 231 generates an electric signal in correspondence to the light representing the image of the cells. The first CCD camera 230A corresponds to the first signal generator 230 described in the context of the first embodiment. In the present embodiment, the first imaging device is exemplified by the first CCD camera 230A. The first signal is exemplified by the electric signal which is generated by the first imaging surface 231.

The microscope device 200A includes a first connector 201 which electrically couples the first CCD camera 230A to the personal computer 320A. The electric signal generated by the first imaging surface 231 is output to the personal computer 320A through the first connector 201.

The second lens barrel 242A includes a microscope objective lens 243, an afocal zoom unit 244, an imaging lens 245 and a barrel 246. The microscope objective lens 243 is situated between the afocal zoom unit 244 and the beam splitter 210A. The afocal zoom unit 244 is situated between the microscope objective lens 243 and the imaging lens 245. The imaging lens 245 is situated between the afocal zoom unit 244 and the barrel 246. The barrel 246 is situated between the imaging lens 245 and the second CCD camera 250A.

The second cam driver 241A uses a cam to drive the afocal zoom unit 244. The second lens barrel 242A corresponds to the second lens mechanism 242 described in the context of the first embodiment. The second cam driver 241A corresponds to the second driver 241 described in the context of the first embodiment.

The second CCD camera 250A includes a second imaging surface 251. The second cam driver 241A drives the second lens barrel 242A to make the second lens barrel 242A form an image of the cells propagating along the second optical axis SOA at various magnifications on the second imaging surface 251. The second imaging surface 251 generates an electric signal in correspondence to the light representing the image of the cells. The second CCD camera 250A corresponds to the second signal generator 250 described in the context of the first embodiment. In the present embodiment, the second imaging device is exemplified by the second CCD camera 250A. The second signal is exemplified by the electric signal which is generated by the second imaging surface 251.

The microscope device 200A includes a second connector 202 which electrically couples the second CCD camera 250A to the personal computer 320A. The electric signal generated by the second imaging surface 251 is output to the personal computer 320A through the second connector 202.

The microscope device 200A includes a third connector 203 which electrically couples the controller 260A to the personal computer 320A. The controller 260A controls the first and second cam drivers 221A, 241A.

When the target optical magnification set by an observer is larger than “1×” and the optical magnification set by the first lens barrel 222A is smaller than “1×”, the controller 260A may control the first cam driver 221A to change the optical magnification set by the first lens barrel 222A toward “1×”. Meanwhile, the optical magnification set by the second lens barrel 242A is maintained at “1×”. In addition, an image signal representing an image of the cells captured by the first CCD camera 230A is output from the personal computer 320A to the display device 400. Therefore, the display device 400 displays the image of the cells captured by the first CCD camera 230A.

The controller 260A then generates a request signal, which requests to switch the image displayed by the display device 400 from the image of the cells captured by the first CCD camera 230A to the image of the cells captured by the second CCD camera 250A when the optical magnification set by the first lens barrel 222A becomes “1×”. The request signal is output from the controller 260A to the personal computer 320A. The personal computer 320A outputs an image signal representing the image of the cells captured by the second CCD camera 250A in response to the request signal. Accordingly, the display device 400 displays the image of the cells captured by the second CCD camera 250A.

The controller 260A generates a drive signal for driving the second cam driver 241A in synchronization with the generation of the request signal. The drive signal is output from the controller 260A to the second cam driver 241A. The second cam driver 241A drives the second lens barrel 242A in response to the drive signal. Accordingly, the optical magnification set by the second lens barrel 242A gradually increases from “1×”. The image of the cells during the increase in optical magnification is displayed on the display device 400.

When the target optical magnification set by the observer is smaller than “1×” and the optical magnification set by the second lens barrel 242A is larger than “1×”, the controller 260A may control the second cam driver 241A to change the optical magnification set by the second lens barrel 242A toward “1×”. Meanwhile, the optical magnification set by the first lens barrel 222A is maintained at “1×”. In addition, an image signal representing an image of the cells captured by the second CCD camera 250A is output from the personal computer 320A to the display device 400. Therefore, the display device 400 displays the image of the cells captured by the first CCD camera 250A.

The controller 260A then generates a request signal which requests to switch the image displayed by the display device 400 from the image of the cells captured by the second CCD camera 250A to the image of the cells captured by the first CCD camera 230A when the optical magnification set by the second lens barrel 242A becomes “1×”. The request signal is output from the controller 260A to the personal computer 320A. The personal computer 320A outputs an image signal representing the image of the cells captured by the first CCD camera 230A in response to the request signal. Accordingly, the display device 400 displays the image of the cells captured by the first CCD camera 230A.

The controller 260A generates a drive signal for driving the first cam driver 221A in synchronization with the generation of the request signal. The drive signal is output from the controller 260A to the first cam driver 221A. The first cam driver 221A drives the first lens barrel 222A in response to the drive signal. Accordingly, the optical magnification set by the first lens barrel 222A gradually decreases from “1×”. The image of the cells during the decrease in optical magnification is displayed on the display device 400.

The microscope device 200A further includes a third CCD camera 510, a single focus lens portion 520 and a fourth connector 204. The third CCD camera 510 and the single focus lens portion 520 are aligned on the first optical axis FOA. The single focus lens portion 520 is situated between the third CCD camera 510 and the culture vessel CV. The culture vessel CV is situated between the single focus lens portion 520 and the first lens barrel 222A. The single focus lens portion 520 focuses at the culture vessel CV. Unlike the first and second lens barrels 222A, 242A, the single focus lens portion 520 does not change optical magnification. In the present embodiment, the third imaging device is exemplified by the third CCD camera 510.

The third CCD camera 510 includes a third imaging surface 511. The single focus lens portion 520 forms an image representing the entire culture vessel CV on the third imaging surface 511. The third imaging surface 511 generates an electric signal in correspondence to light representing an image of the entire culture vessel CV. In the present embodiment, the third signal is exemplified by the electric signal which is generated by the third imaging surface 511.

The fourth connector 204 is used for electrically coupling the third CCD camera 510 to the personal computer 320A. The electric signal generated by the third imaging surface 511 is output to the personal computer 320A through the fourth connector 204.

The microscope device 200A further includes a ring illuminator 530 and a first illumination power supply 540. The controller 260A controls the first illumination power supply 540 to turn on or off the ring illuminator 530.

The ring illuminator 530 is situated between the first lens barrel 222A and the culture vessel CV. The ring illuminator 530 includes a plurality of white LEDs 531. Since the white LEDs 531 are arranged in a ring shape so as to surround the first optical axis FOA, the ring illuminator 530 is less likely to interfere with propagation of light along the first optical axis FOA. The ring illuminator 530 may also illuminate the culture vessel CV in dark field. Accordingly, the cells emit light in white hue. Therefore, an observer may grasp positions of the cells in the culture vessel CV.

While the image signal representing the image of the cells obtained by the first CCD camera 230A is output from the controller 260A to the personal computer 320A, the first illumination power supply 540 turns on the ring illuminator 530 under control of the controller 260A. Since the entire culture vessel CV is illuminated, brightness of the image of the cells obtained by the first CCD camera 230A is increased to an appropriate level. In the present embodiment, the first illuminator is exemplified by the ring illuminator 530.

While the controller 260A makes the personal computer 320A output the image signal representing the image of the cells obtained by the second CCD camera 250A, the first illumination power supply 540 may turn off the ring illuminator 530 under control of the controller 260A. Accordingly, there is a decrease in electrical power consumed by the ring illuminator 530. Therefore, the illumination light is illuminated to the imaging system of each of the first and second imaging devices in an appropriate range so that degrade in image quality is less likely to be caused by light illuminated to unnecessary parts.

The microscope device 200A further includes a transmissive illuminator 550, a second illumination power supply 560 and a plane beam splitter 570. The controller 260A controls the second illumination power supply 560 to turn on or off the transmissive illuminator 550.

The transmissive illuminator 550 forms an optical path OP substantially perpendicular to the first optical axis FOA. The plane beam splitter 570 is situated between the ring illuminator 530/the culture vessel CV and the first lens barrel 222A. The plane beam splitter 570 is inclined at an angle of substantially 45° from the first optical axis FOA and the optical path OP. In the present embodiment, the illumination mirror is exemplified by the plane beam splitter 570.

The transmissive illuminator 550 includes a white LED 551, a condenser lens 552 and an illumination lens 553. The white LED 551 is turned on or off by the second illumination power supply 560 under control of the controller 260A.

White light emitted from the white LED 551 is condensed by the condenser lens 552 toward the illumination lens 553. The white light is emitted from the transmissive illuminator 550 through the illumination lens 553. The white light then reaches the plane beam splitter 570.

The plane beam splitter 570 reflects the white light from the transmissive illuminator 550 toward the culture vessel CV. The white light propagates along the first optical axis FOA, and then reaches the boundary between the first and second blocks 280, 290. Meanwhile, the white light passes through the ring illuminator 530. Since the ring illuminator 530 is situated so as to surround the first optical axis FOA as described above, the ring illuminator 530 is less likely to interfere with propagation of the white light propagating from the plane beam splitter 570 to the beam splitter 210A.

As described with reference to FIG. 6, the half mirror film 271 is formed at the boundary between the first and second blocks 280, 290. Since the half mirror film 271 reflects the white light toward the second CCD camera 250A, an image of the cells in the culture vessel CV is obtained by the second CCD camera 250A.

The plane beam splitter 570 allows passage of light directed to the first CCD camera 230A along the first optical axis FOA. Therefore, the plane beam splitter 570 is less likely to interfere with acquisition of the cell image by the first CCD camera 230A.

While the image signal representing the image of the cells obtained by the second CCD camera 250A is output from the controller 260A to the personal computer 320A, the second illumination power supply 560 turns on the transmissive illuminator 550 under control of the controller 260A. Since the culture vessel CV is appropriately transilluminated by the transmissive illuminator 550, brightness of the image of the cells obtained by the second CCD camera 250A is increased to an appropriate level. In the present embodiment, the second illuminator is exemplified by the transmissive illuminator 550. The transmissive illuminator 550 may use a ring slit to perform phase contrast illumination. When the microscope objective lens 243 has a phase film, a phase-contrast microscopic image may be made. Accordingly, an observer may observe the cells with a high contrast image.

While the controller 260A makes the personal computer 320A output the image signal representing the image of the cells obtained by the first CCD camera 230A, the second illumination power supply 560 may turn off the transmissive illuminator 550 under control of the controller 260A. Accordingly, there is a decrease in electrical power consumed by the transmissive illuminator 550. Therefore, the illumination light is illuminated to the imaging system of each of the first and second imaging devices in an appropriate range so that there is little degrade in image quality caused by light illuminated to unnecessary parts.

The microscope device 200A further includes a stage 610 and a stage driver 620. The stage driver 620 moves the stage 610 substantially perpendicularly to the first optical axis FOA under control of the controller 260A. In short, the stage driver 620 moves the stage 610 substantially in parallel to the second optical axis SOA under control of the controller 260A. In the present embodiment, the stage mechanism is exemplified by the stage 610 and the stage driver 620.

The culture vessel CV is mounted on the stage 610. An observer may move the stage 610 to observe a desired area in the culture vessel CV.

### (First Lens Barrel)

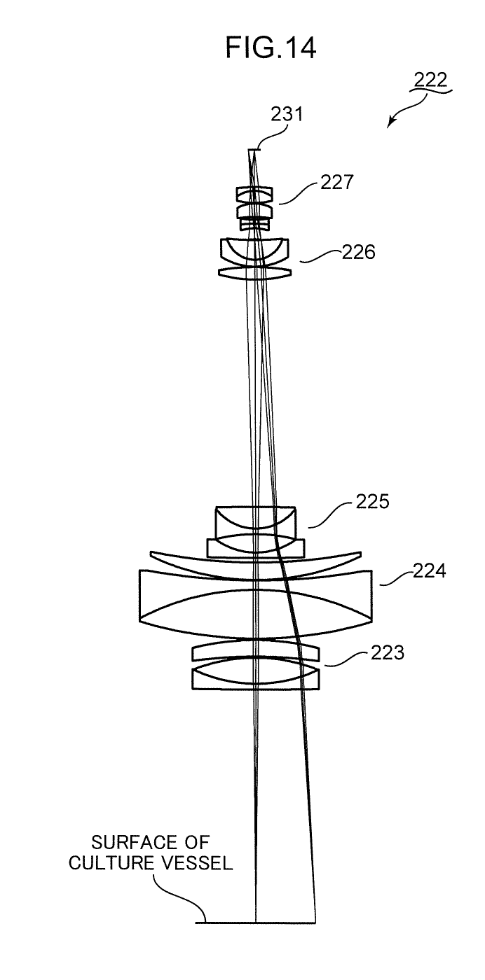

FIG. 14 is a schematic view of the first lens barrel 222A. The first lens barrel 222A is described with reference to FIGS. 13 and 14.

As described above, the first lens barrel 222A includes the close-up lens 223, the focusing lens 224, the variator 225, the compensator 226 and the relay lens 227. The close-up lens 223, the focusing lens 224, the variator 225, the compensator 226 and the relay lens 227 are arranged in order from a surface of the culture vessel CV to the first imaging surface 231 of the first CCD camera 230A. The focusing lens 224, the variator 225, the compensator 226 and the relay lens 227 function as a zoom lens. In the present embodiment, the first movable lens is exemplified by the compensator 226 and the relay lens 227.

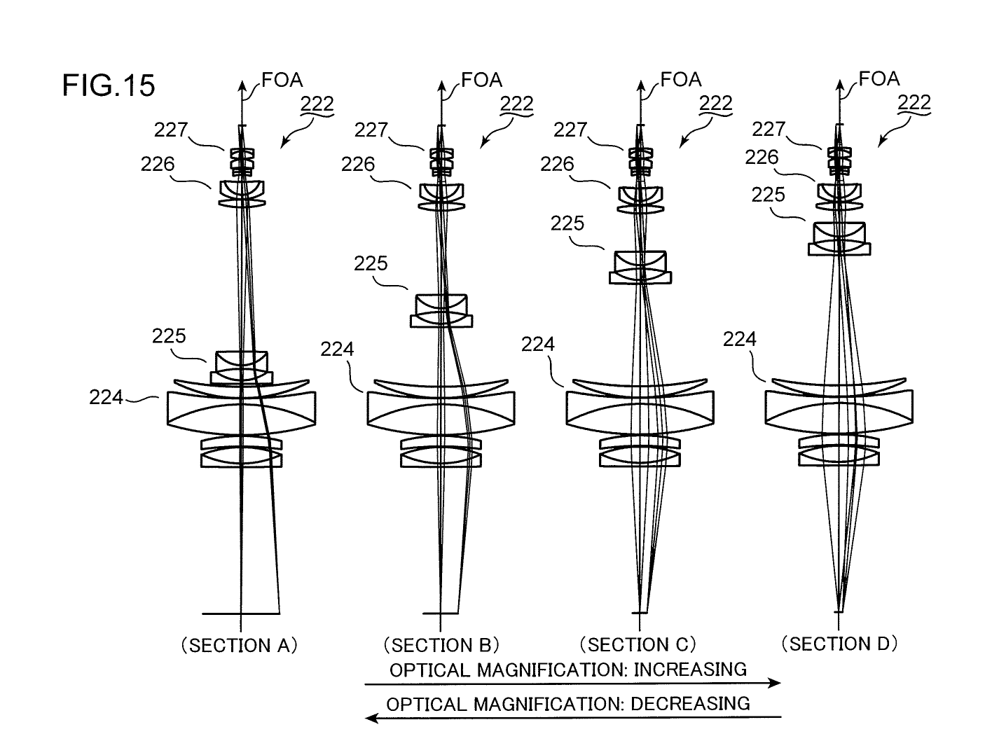

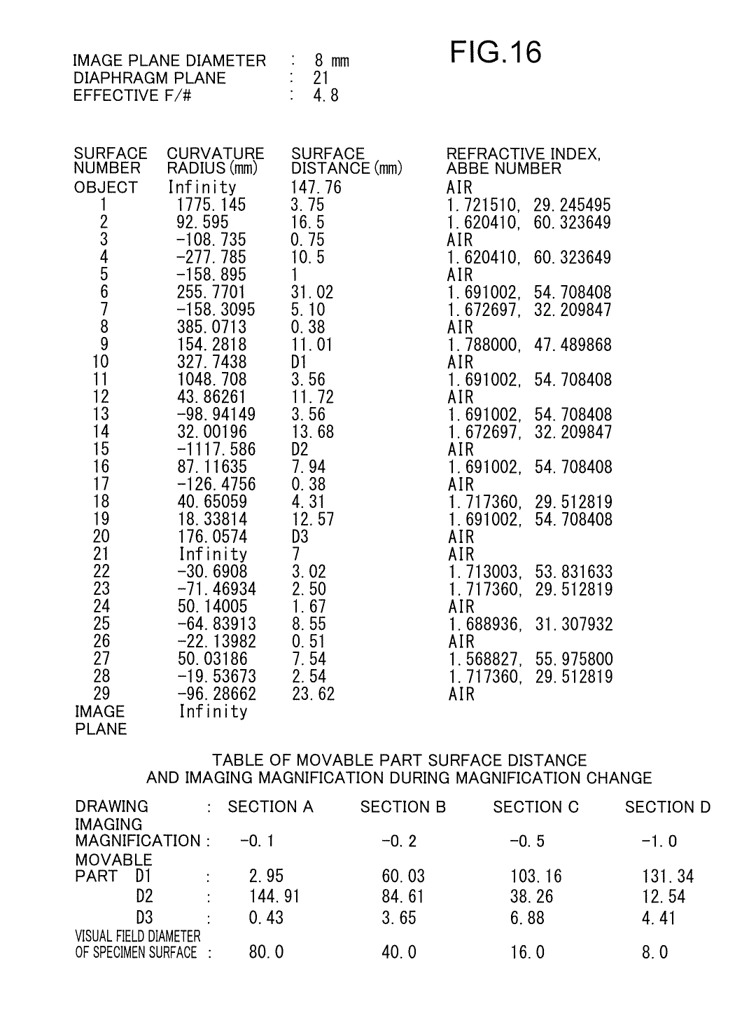

FIG. 15 is a schematic view showing operation of the first lens barrel 222A. FIG. 16 is lens data of the first lens barrel 222A shown in FIG. 15. The operation of the first lens barrel 222A is described with reference to FIGS. 13, 15 and 16.

The first lens barrel 222A shown in the section A of FIG. 15 sets the lowest optical magnification. The first lens barrel 222A shown in the section D of FIG. 15 sets the highest optical magnification. The first lens barrel 222A shown in the section B of FIG. 15 sets the second lowest optical magnification. The first lens barrel 222A shown in the section C of FIG. 15 sets the second highest optical magnification.

The first cam driver 221A moves the variator 225 and the compensator 226 between the focusing lens 224 and the relay lens 227 along the first optical axis FOA. When high optical magnification is set, the first cam driver 221A moves the variator 225 away from the focusing lens 224. When low optical magnification is set, the first cam driver 221A gets variator 225 closer to the focusing lens 224. The first cam driver 221A displaces the compensator 226 by a minute distance in response to the movement of the variator 225.

FIG. 16 shows lens data in correspondence to the sections A to D of FIG. 15 in detail. However, the design of the first lens barrel 222A is not limited to the detailed designs represented in FIGS. 15 and 16. A known lens structure for changing magnification may be applicable to the first lens barrel 222A.

### (Second Lens Barrel)

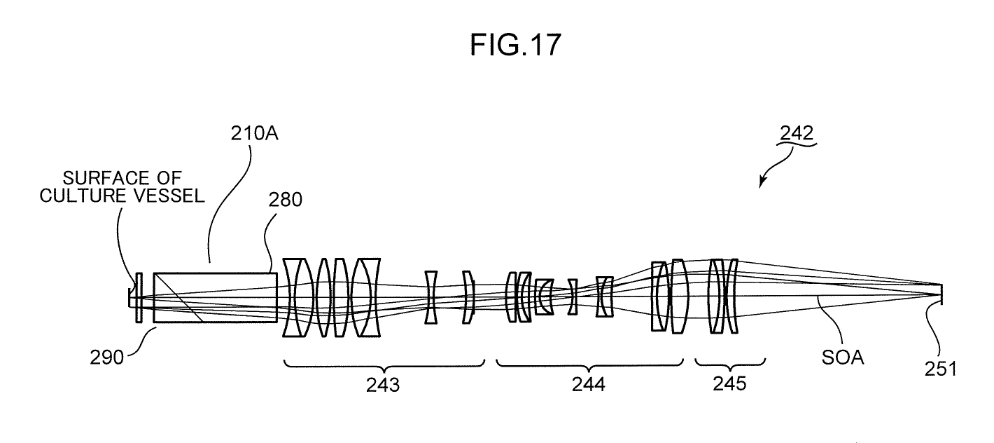

FIG. 17 is a schematic view of the second lens barrel 242A. The second lens barrel 242A is described with reference to FIGS. 6, 13 and 17.

The beam splitter 210A is shown in FIG. 17. In FIG. 17, the folding of the optical path at the boundary surface between the first and second blocks 280, 290 is unfolded so that a surface of the culture vessel CV is depicted on the second optical axis SOA.

As described above, the second lens barrel 242A includes the afocal system microscope objective lens 243, the afocal zoom unit 244 and the imaging lens 245. The microscope objective lens 243, the afocal zoom unit 244 and the imaging lens 245 are arranged in order from the beam splitter 210A toward the second imaging surface 251 of the second CCD camera 250A.

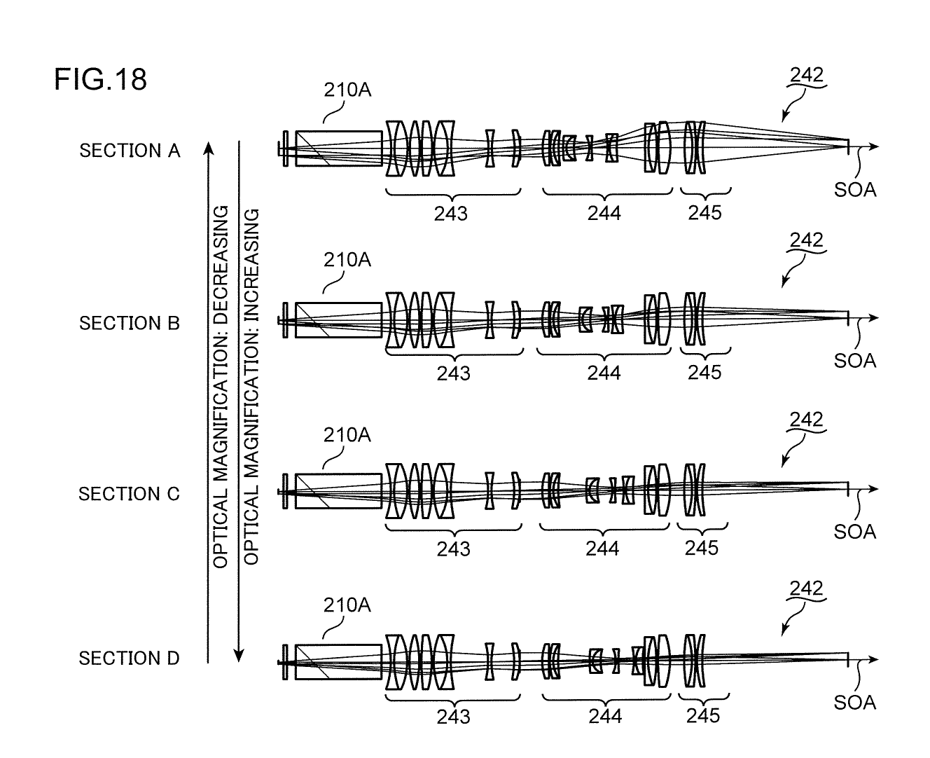

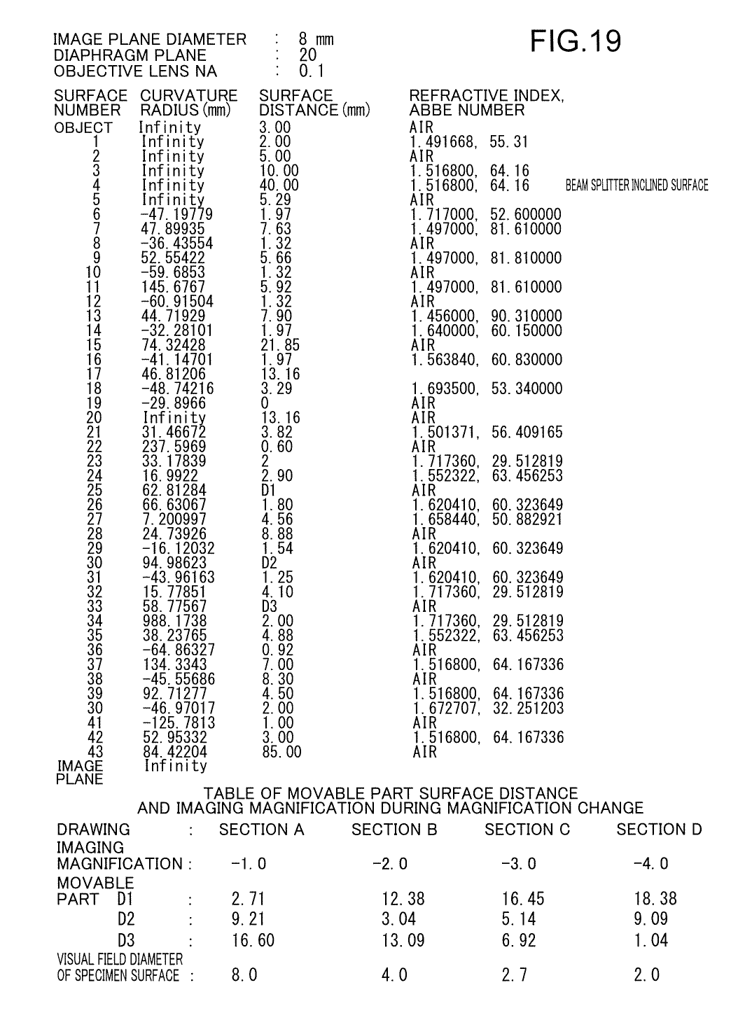

FIG. 18 is a schematic view showing operation of the second lens barrel 242A. FIG. 19 is lens data of the second lens barrel 242A shown in FIG. 18. The operation of the second lens barrel 242A is described with reference to FIGS. 13, 18 and 19.

The second lens barrel 242A shown in the section A of FIG. 18 sets the lowest optical magnification. The second lens barrel 242A shown in the section D of FIG. 18 sets the highest optical magnification. The second lens barrel 242A shown in the section B of FIG. 18 sets the second lowest optical magnification. The second lens barrel 242A shown in the section C of FIG. 18 sets the second highest optical magnification.

The second cam driver 241A moves lenses in the afocal zoom unit 244 along the second optical axis SOA, the lenses being used for the afocal zoom unit 244. In the present embodiment, the second movable lens is exemplified by the lenses moved in the afocal zoom unit 244.

FIG. 19 shows lens data in correspondence to the sections A to D of FIG. 18 in detail. However, a design of the second lens barrel 242A is not limited to the detailed designs shown in FIGS. 18 and 19. A known lens structure for changing magnification may be applicable to the second lens barrel 242A.

### (Stage)

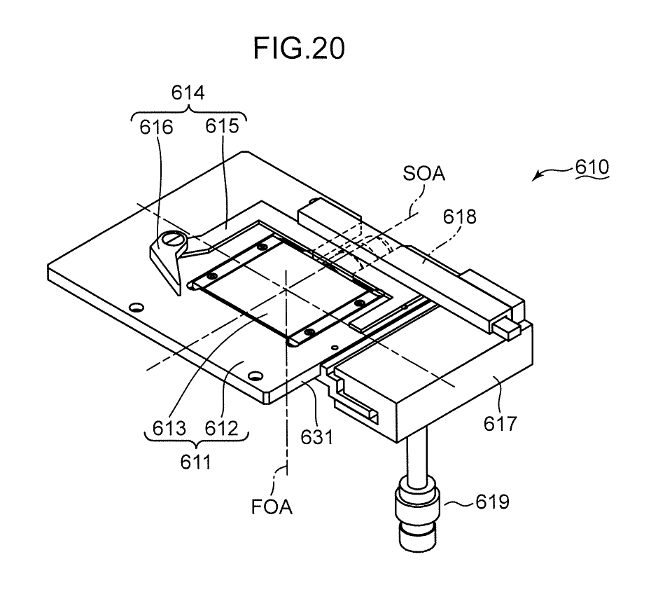

FIG. 20 is a schematic perspective view of the stage 610. The stage 610 is described with reference to FIGS. 13 and 20.

The stage 610 includes a support plate 611. The support plate 611 supports the culture vessel CV. The support plate 611 includes a C-shaped frame plate 612 and a transparent plate 613. The transparent plate 613 covers an opening formed in the C-shaped frame plate 612. The culture vessel CV is mounted on the transparent plate 613. The transparent plate 613 may be a glass plate or an acrylic plate. The transparent plate 613 appropriately supports the culture vessel CV to prevent the microscope device 200A from being contaminated with culture media or alike overflowed from the culture vessel CV.

The support plate 611 is mounted so that the transparent plate 613 traverses the first optical axis FOA. Therefore, an observer may appropriately observe the cells in the culture vessel CV on the transparent plate 613.

The stage 610 includes a clamp mechanism 614. The clamp mechanism 614 mounted on the C-shaped frame plate 612 includes a substantially C-shaped arm 615 surrounding the transparent plate 613 and a rotatable claw 616 fixed at an end of the aim 615. An observer may use the claw 616 to fix the culture vessel CV on the transparent plate 613.

The C-shaped frame plate 612 includes a first rail mechanism 617, a second rail mechanism 618 and an operation portion 619. The C-shaped frame plate 612 includes a side surface 631 extending in a direction substantially in parallel to the second optical axis SOA.

The first rail mechanism 617 is mounted on the side surface 631. The first rail mechanism 617 extends in a direction substantially in parallel to the second optical axis SOA. The stage driver 620 may operate the operation portion 619 and use the first rail mechanism 617 to move the second rail mechanism 618 and the clamp mechanism 614 in the direction substantially in parallel to the second optical axis SOA. Alternatively, an observer may manually operate the operation portion 619 and use the first rail mechanism 617 to move the second rail mechanism 618 and the clamp mechanism 614 in the direction substantially in parallel to the second optical axis SOA.

The second rail mechanism 618 is fixed on the first rail mechanism 617. Unlike the first rail mechanism 617, the second rail mechanism 618 extends in a direction substantially perpendicular to the second optical axis SOA. The stage driver 620 may operate the operation portion 619 and use the second rail mechanism 618 to move the clamp mechanism 614 in the direction substantially perpendicular to the second optical axis SOA. Alternatively, an observer may manually operate the operation portion 619 and use the second rail mechanism 618 to move the clamp mechanism 614 in the direction substantially perpendicular to the second optical axis SOA.

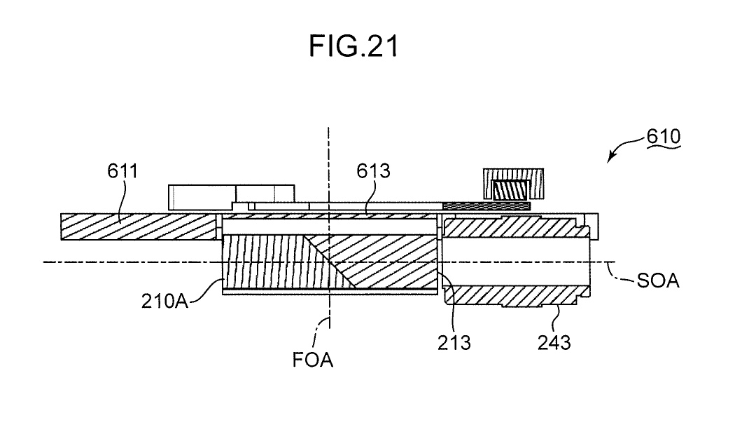

FIG. 21 is a schematic cross-sectional view of the stage 610 along the second optical axis SOA. The stage 610 is further described with reference to FIGS. 13 to 21.

The support plate 611 may support the beam splitter 210A and the microscope objective lens 243. The support plate 611 supports the beam splitter 210A under the transparent plate 613. Since the support plate 611 moves the beam splitter 210A away from the transparent plate 613, there is little damage to the beam splitter 210A. The support plate 611 supports the microscope objective lens 243 so that the microscope objective lens 243 is adjacent to the second emission end surface 213 of the beam splitter 210A. Accordingly, light propagating along the first optical axis FOA and light propagating along the second optical axis SOA are captured by the first imaging surface 231/the third imaging surface and the second imaging surface 251, respectively. In addition, collision is less likely to happen to the stage 610 and the microscope objective lens 243 since the microscope objective lens 243 is moved along with the stage 610.

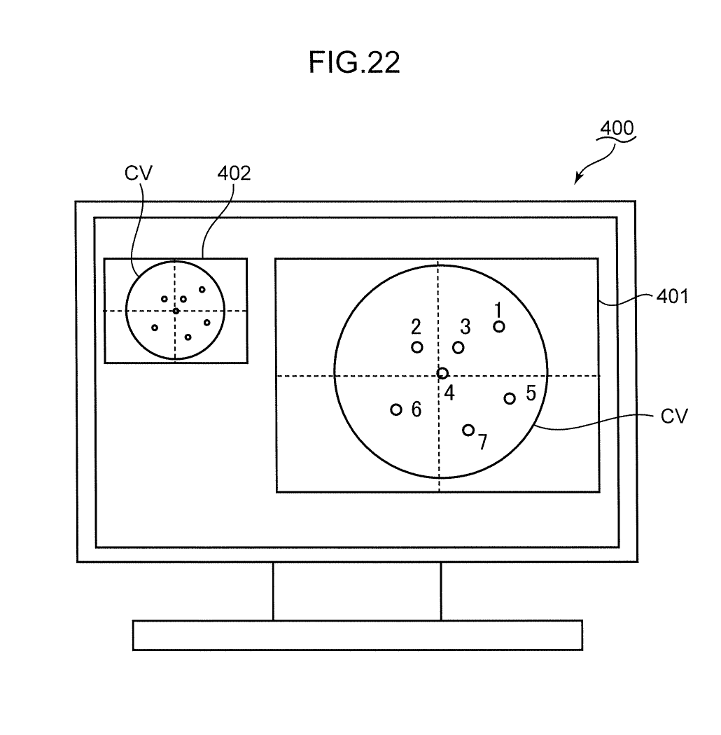

FIG. 22 is a schematic front view of the display device 400. The display device 400 is described with reference to FIGS. 13 and 22.

The personal computer 320A generates an image signal so that the display device 400 displays a first window 401 and a second window 402 narrower than the first window 401. An image representing the cell image obtained by the first or second CCD camera 230A, 250A is displayed on the first window 401. An image representing the cell image obtained by the third CCD camera 510 is displayed on the second window 402. Cross-hairs are displayed on the first and second windows 401, 402.

In FIG. 22, the culture vessel CV and seven cell colonies cultivated in the culture vessel CV are illustrated on the first and second windows 401, 402. One of numbers from “1” to “7” is assigned to each of the cell colonies for clarification of the description.

As described above, a focus of the third CCD camera 510 is set so that the third CCD camera 510 may obtain an entire image of the culture vessel CV. Therefore, the entire culture vessel CV is displayed on the second window 402.

In FIG. 22, an image obtained by the first CCD camera 230A is displayed on the first window 401. When the first lens barrel 222A sets low optical magnification as shown in FIG. 22, the entire culture vessel CV is also displayed on the first window 401 on which an image obtained by the first CCD camera 230A is displayed. An observer may select an observation target more precisely from the seven cell colonies in the culture vessel CV.

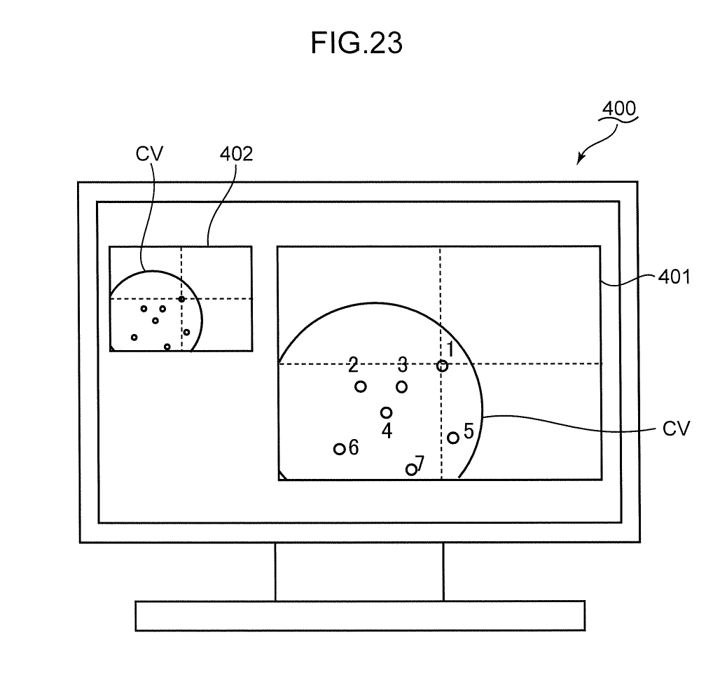

FIG. 23 is a schematic front view of the display device 400 when the observer moves the stage 610. The display device 400 is described with reference to FIGS. 13, 22 and 23.

In the following description, the observer selects the cell colony, to which the number “1” is assigned (referred to as the cell colony “1”), from the seven cell colonies. When the observer operates the input device 310A to specify the cell colony “1”, the stage driver 620 moves the stage 610. Accordingly, the cell colony “1” is aligned to the cross-hairs. The input information is exemplified by the information input to the input device 310A by the observer for specifying the cell colony “1”.

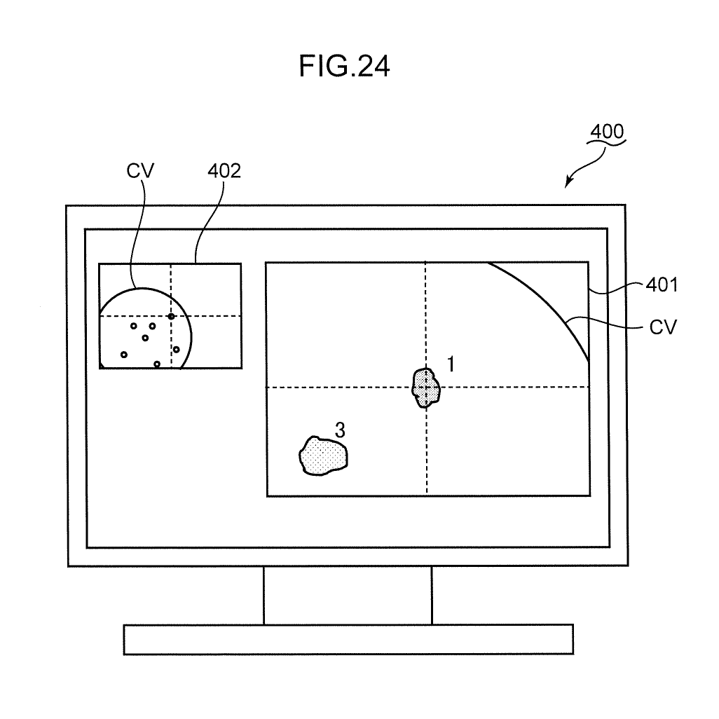

FIG. 24 is a schematic front view of the display device 400 when the observer requests a change of optical magnification. The display device 400 is described with reference to FIGS. 13, 23 and 24.

The observer may operate the input device 310A to request a change of optical magnification. Information about the optical magnification requested by the observer is output from the personal computer 320A to the controller 260A. The controller 260A controls the first cam driver 221A at first to drive the first lens barrel 222A. Accordingly, the optical magnification defined by the first lens barrel 222A is gradually increased. The controller 260A then starts controlling the second cam driver 241A when the optical magnification defined by the first lens barrel 222A reaches “1×”. At the same time, a request signal for requesting to switch an image displayed on the first window 401 from an image obtained by the first CCD camera 230A to an image obtained by the second CCD camera 250A is output from the controller 260A to the personal computer 320A. The display device 400 switches the image displayed on the first window 401 from the image obtained by the first CCD camera 230A to the image obtained by the second CCD camera 250A in response to the request signal. Since the first and second optical axes FOA, SOA coincide at the boundary between the first and second blocks 280, 290, the intersection of the cross-hairs coincides with the cell colony “1” even after the display switchover in the first window 401. The second cam driver 241A drives the second lens barrel 242A under control of the controller 260A to gradually increase the optical magnification from “1×”. Accordingly, an area occupied by the cell colony “1” in the first window 401 is gradually spread. On the other hand, the optical magnification for the image displayed in the second window 402 is constant.

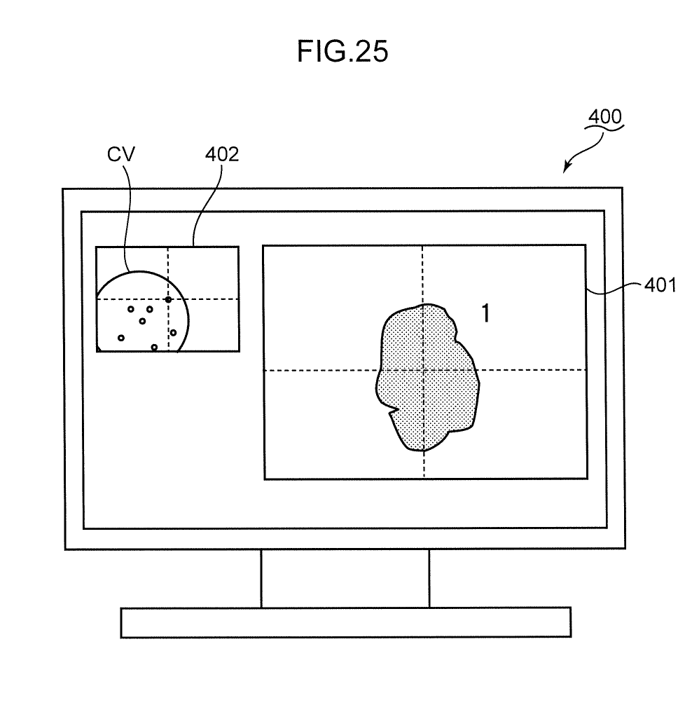

FIG. 25 is a schematic front view of the display device 400 when the optical magnification reaches the target value. The display device 400 is described with reference to FIGS. 13, 24 and 25.

When the optical magnification reaches the target value, the cell colony “1” is largely displayed on the first window 401. Accordingly, the observer may observe the cell colony “1” in detail. On the other hand, the substantially entire culture vessel CV is displayed on the second window 402. Therefore, the observer may easily grasp a position of the cell colony “1” in the culture vessel CV. For instance, if the observer then tries to observe another cell colony, the observer may easily and accurately determine a moving direction of the stage 610 on the basis of the image in the second window 402. In addition, when image data displayed by the display device 400 is recorded, the observer may efficiently perform image data processes as well since positional data of the cell colony “1” in the culture vessel CV is also recorded by the image displayed on the second window 402. Accordingly, observation work of the cell colonies becomes efficient. In the present embodiment, the enlarged image is exemplified by the image displayed on the first window 401. The entire image is exemplified by the image displayed on the second window 402.

The observation device 100A may include other various functions. For instance, the observation device 100A may automatically identify a position of a colony in the culture vessel CV.

Techniques about the exemplary observation devices described in the context of the aforementioned various embodiments include the following features.

An observation device according to one aspect of the aforementioned embodiments has a first optical axis and a second optical axis different in direction from the first optical axis. The observation device includes: a splitter configured to split image light into first light along the first optical axis and second light along the second optical axis, the image light representing an image of an observation target; and a magnifier configured to change optical magnification for at least one of a first image represented by the first light and a second image represented by the second light. The splitter includes a first area, which receives the image light, and a second area, which receives the image light next to the first area. The first and second areas allow partial passage of the image light to generate the first light. The first area partially reflects the image light to generate the second light.

According to the aforementioned configuration, the splitter splits the image light into the first light along the first optical axis and the second light along the second optical axis, the image light representing an image of the observation target. The first light is generated by passage through the first and second areas. The second light is generated by reflection from the first area.

Since the magnifier changes optical magnification of at least one of the first image represented by the first light and the second image represented by the second light, an observer may make the optical magnification of the first image different from the optical magnification of the second image. Since the splitter splits the image light into the first light and the second light, the observer may switch an image of the observation target from the first image to the second image or from the second image to the first image without moving the observation target. Therefore, the observer may easily adjust magnification over a wide range.

Since both of the first and second areas allow partial passage of the image light, the observer is less likely to recognize a boundary between an area of the first image represented by the first light passing through the first area and an area of the first image represented by the first light passing through the second area. Therefore, the observer may observe the clear first image.

With regard to the aforementioned configuration, the second area may include a darkening portion, which allows passage of a light quantity smaller than a light quantity of the image light incident on the second area. The darkening portion may decrease a difference between a quantity of light transmitted along the first optical axis from the first area and a quantity of light transmitted along the first optical axis from the second area.

According to the aforementioned configuration, since the darkening portion allows passage of a light quantity smaller than a light quantity of the image light incident on the second area, there is a decrease in a difference between a quantity of light transmitted along the first optical axis from the first area and a quantity of light transmitted along the first optical axis from the second area. Therefore, an observer is less likely to recognize a boundary between an area of the first image represented by the first light transmitted through the first area and an area of the first image represented by the first light transmitted through the second area.

With regard to the aforementioned configuration, the magnifier includes: a first signal generator, which generates a first signal in correspondence to the first image; a second signal generator, which generates a second signal in correspondence to the second image; and an output signal generator, which selectively performs a first generation process for generating a first output signal in correspondence to the first signal and a second generation process for generating a second output signal in correspondence to the second signal. The output signal generator may switch a generation process of an output signal between the first and second generation processes in response to a difference between first optical magnification for the first image and second optical magnification for the second image.

According to the aforementioned configuration, the first signal generator generates the first signal in correspondence to the first image. The second signal generator generates the second signal in correspondence to the second image. The output signal generator performs the first generation process to generate a first output signal in correspondence to the first signal. The output signal generator performs the second generation process to generate a second output signal in correspondence to the second signal. Since the output signal generator switches a generation process of the output signal between the first and second generation processes in response to a difference between the first optical magnification for the first image and the second optical magnification for the second image, an observer may adjust optical magnification over a wide range.

With regard to the aforementioned configuration, the output signal generator may switch the generation process from the first generation process to the second generation process if the difference between the first optical magnification and the second optical magnification becomes a predetermined value while the output signal generator performs the first generation process.

According to the aforementioned configuration, since the output signal generator switches the generation process from the first generation process to the second generation process if a difference between the first optical magnification and the second optical magnification becomes the predetermined value while the output signal generator performs the second generation process, the observation device may allow an observer to observe the second image without recognization of the switchover from the first image to the second image.

With regard to the aforementioned configuration, the output signal generator may switch the generation process from the second generation process to the first generation process if the difference between the first optical magnification and the second optical magnification becomes a predetermined value while the output signal generator performs the second generation process.

According to the aforementioned configuration, since the output signal generator switches over the generation process from the second generation process to the first generation process if a difference between the first optical magnification and the second optical magnification becomes the predetermined value while the output signal generator performs the second generation process, the observation device may allow the observer to observe the first image without recognition of switchover from the second image to the first image.

With regard to the aforementioned configuration, the magnifier may include: a first adjuster, which adjusts the optical magnification for the first image; a second adjuster, which adjusts the optical magnification for the second image; and a controller, which controls the output signal generator, the first adjuster and the second adjuster.

According to the aforementioned configuration, the first adjuster adjusts the optical magnification for the first image under control of the controller. The second adjuster adjusts the optical magnification for the second image under control of the controller. Therefore, an observer may observe the first and second images under appropriate adjustment to optical magnification.

With regard to the aforementioned configuration, the first adjuster may include a first lens mechanism, which is situated on the first optical axis, and a first driver, which drives the first lens mechanism. The second adjuster may include a second lens mechanism, which is situated on the second optical axis, and a second driver, which drives the second lens mechanism. The first signal generator may include a first imaging device, which generates the first signal in response to the first light passing through the first lens mechanism. The second signal generator may include a second imaging device, which generates the second signal in response to the second light passing through the second lens mechanism.

According to the aforementioned configuration, the first driver may drive the first lens mechanism situated on the first optical axis to adjust the optical magnification for the first image. The second driver may drive the second lens mechanism situated on the second optical axis to adjust the optical magnification for the second image. Since the first imaging device generates the first signal in correspondence to the first light passing through the first lens mechanism, an observer may observe the first image under appropriate adjustment to magnification. Since the second imaging device generates the second signal in correspondence to the second light passing through the second lens mechanism, the observer may observe the second image under appropriate adjustment to magnification.

With regard to the aforementioned configuration, the first lens mechanism may include a first movable lens. The second lens mechanism may include a second movable lens. The first driver may move the first movable lens along the first optical axis to adjust the optical magnification for the first image. The second driver may move the second movable lens along the second optical axis to adjust the optical magnification for the second image.

According to the aforementioned configuration, since the first driver moves the first movable lens along the first optical axis, the optical magnification for the first image is appropriately adjusted. Since the second driver moves the second movable lens along the second optical axis, the optical magnification for the second image is appropriately adjusted.

With regard to the aforementioned configuration, the observation device may further include: a third imaging device, which is situated on the first optical axis; a stage mechanism, which supports the observation target between the first lens mechanism and the third imaging device; and a display device, which displays an image in correspondence to the output signal. The third imaging device may generate a third signal which represents the observation target captured at fixed magnification. The controller may control the output signal generator to display an enlarged image and an entire image on the display device, the enlarged image being represented by one of the first and second output signals whereas the entire image is represented by the third signal.

According to the aforementioned configuration, since the stage mechanism supports the observation target between the first lens mechanism and the third imaging device, the observation target is observed with the first imaging device and the third imaging device. Since the splitter generates the second light along the second optical axis by reflection at the first area, the observation target is observed with the second imaging device.

Since the display device displays an enlarged image, which is represented by one of the first and second output signals, and an entire image, which is represented by the third signal, under control of the controller, an observer may simultaneously observe the entire image and the observation image. Therefore, the observer may easily obtain positional information of the observation target.

With regard to the aforementioned configuration, the observation device may further include an input interface configured to receive input information about the enlarged image. The controller may drive the stage mechanism in response to the input information.

According to the aforementioned configuration, since the controller drives the stage mechanism in response to the input information received by the input interface, an observer may observe a desired enlarged image.

With regard to the aforementioned configuration, the controller may control at least one of the first and second drivers in response to the input information.

According to the aforementioned configuration, since the controller controls at least one of the first and second drivers in response to the input information received by the input interface, an observer may observe an enlarged image under desired adjustment to magnification.

With regard to the aforementioned configuration, the observation device may further include: a first illuminator, which illuminates the observation target while the controller makes the output signal generator perform the first generation process; and a second illuminator, which illuminates the observation target while the controller makes the output signal generator perform the second generation process.

According to the aforementioned configuration, since the first illuminator illuminates the observation target while the controller makes the output signal generator perform the first generation process, an observer may appropriately observe the first image. Since the second illuminator illuminates the observation target while the controller makes the output signal generator perform the second generation process, the observer may appropriately observe the second image.

With regard to the aforementioned configuration, the controller may turn off the first illuminator while the output signal generator performs the second generation process. The controller may turn off the second illuminator while the output signal generator performs the first generation process.

According to the aforementioned configuration, since the controller turns off the first illuminator while the output signal generator performs the second generation process, the first illuminator does not unnecessarily consume electrical power. Since the controller turns off the second illuminator while the output signal generator performs the first generation process, the second illuminator does not unnecessarily consume electrical power. Therefore, the illumination light is illuminated to the imaging system of each of the first and second imaging devices in an appropriate range so that there is little degrade in image quality resultant from light illuminated to unnecessary parts.

With regard to the aforementioned configuration, the observation device may further include an illumination mirror situated between the first lens mechanism and the observation target. The second illuminator may emit illumination light toward the illumination mirror. The illumination mirror may reflect the illumination light toward the observation target. The splitter may be situated so that the first area receives the illumination light passing through the observation target.

According to the aforementioned configuration, the second illuminator emits illumination light toward the illumination mirror situated between the first lens mechanism and the observation target. Since the splitter is situated so that the first area receives the illumination light passing through the observation target, an observer may appropriately observe the second image.

With regard to the aforementioned configuration, the illumination mirror may be situated on the first optical axis to allow passage of the first light propagating along the first optical axis.

According to the aforementioned configuration, since the illumination mirror allows passage of the first light propagating along the first optical axis, an observer may appropriately observe the first image.

An signal output method according to another aspect of the aforementioned embodiments is used for selectively outputting a first output signal, which represents a first image represented by first light propagating along a first optical axis, and a second output signal, which represents a second image represented by second light propagating along a second optical axis different in direction from the first optical axis, as an output signal. The signal output method includes a step of switching an output of the output signal between the first and second output signals in response to a difference between first optical magnification for the first image and second optical magnification for the second image.

According to the aforementioned configuration, since an output of the output signal is switched between the first and second output signals in response to a difference between the first optical magnification for the first image represented by the first light propagating along the first optical axis and the second optical magnification for the second image represented by the second light propagating along the second optical axis different in direction from the first optical axis, an observer may selectively observe the first and second images without recognization of a switchover between the first and second output signals.

A signal generation program according to another aspect of the aforementioned embodiments causes an output signal generator to selectively generate a first output signal, which represents a first image represented by first light propagating along a first optical axis, and a second output signal, which represents a second image represented by second light propagating along a second optical axis different in direction from the first optical axis, as an output signal. The signal generation program makes the output signal generator execute a step of switching generation of the output signal between the first and second output signals in response to a difference between first optical magnification for the first image and second optical magnification for the second image.

According to the aforementioned configuration, since the generation of the output signal is switched between the first and second output signals in response to a difference between the first optical magnification for the first image represented by the first light propagating along the first optical axis and the second optical magnification for the second image represented by the second light propagating along the second optical axis different in direction from the first optical axis, an observer may selectively observe the first and second images without recognization of a switchover between the first and second output signals.

### INDUSTRIAL APPLICABILITY

The principles of the aforementioned embodiments are suitably applicable to techniques for observing targets.

1. An optical observation device having a first optical axis and a second optical axis different in direction from the first optical axis, the observation device comprising:
a splitter configured to split image light into first light along the first optical axis and second light along the second optical axis, the image light representing an image of an observation target; and
a magnifier configured to change optical magnification for at least one of a first image represented by the first light and a second image represented by the second light,
wherein the splitter includes a first area, which receives the image light, and a second area, which receives the image light next to the first area,
wherein the first and second areas allow partial passage of the image light to generate the first light, and
the first area partially reflects the image light to generate the second light.

2. The observation device according to claim 1,
wherein the second area includes a darkening portion, which allows passage of a light quantity smaller than a light quantity of the image light incident on the second area, and
wherein the darkening portion decreases a difference between a quantity of light transmitted along the first optical axis from the first area and a quantity of light transmitted along the first optical axis from the second area.

3. The observation device according to claim 1,
wherein the magnifier includes: a first signal generator, which generates a first signal in correspondence to the first image; a second signal generator, which generates a second signal in correspondence to the second image; and an output signal generator, which selectively performs a first generation process for generating a first output signal in correspondence to the first signal and a second generation process for generating a second output signal in correspondence to the second signal, and
wherein the output signal generator switches a generation process of an output signal between the first and second generation processes in response to a difference between first optical magnification for the first image and second optical magnification for the second image.

4. The observation device according to claim 3,
wherein the output signal generator switches the generation process from the first generation process to the second generation process if the difference between the first optical magnification and the second optical magnification becomes a predetermined value while the output signal generator performs the first generation process.

5. The observation device according to claim 4,
wherein the output signal generator switches the generation process from the second generation process to the first generation process if the difference between the first optical magnification and the second optical magnification becomes a predetermined value while the output signal generator performs the second generation process.

6. The observation device according to claim 3,
wherein the magnifier includes: a first adjuster, which adjusts the optical magnification for the first image; a second adjuster, which adjusts the optical magnification for the second image; and a controller, which controls the output signal generator, the first adjuster and the second adjuster.

7. The observation device according to claim 6,
wherein the first adjuster includes a first lens mechanism, which is situated on the first optical axis, and a first driver, which drives the first lens mechanism,
wherein the second adjuster includes a second lens mechanism, which is situated on the second optical axis, and a second driver, which drives the second lens mechanism,
wherein the first signal generator includes a first imaging device, which generates the first signal in response to the first light passing through the first lens mechanism, and
wherein the second signal generator includes a second imaging device, which generates the second signal in response to the second light passing through the second lens mechanism.

8. The observation device according to claim 7,
wherein the first lens mechanism includes a first movable lens,
wherein the second lens mechanism includes a second movable lens,
wherein the first driver moves the first movable lens along the first optical axis to adjust the optical magnification for the first image, and
wherein the second driver moves the second movable lens along the second optical axis to adjust the optical magnification for the second image.

9. The observation device according to claim 7, further comprising: a third imaging device, which is situated on the first optical axis; a stage mechanism, which supports the observation target between the first lens mechanism and the third imaging device; and a display device, which displays an image in correspondence to the output signal,
wherein the third imaging device generates a third signal which represents the observation target captured at fixed magnification, and
wherein the controller controls the output signal generator to display an enlarged image and an entire image on the display device, the enlarged image being represented by one of the first and second output signals whereas the entire image is represented by the third signal.

10. The observation device according to claim 9, further comprising an input interface configured to receive input information about the enlarged image,
wherein the controller drives the stage mechanism in response to the input information.

11. The observation device according to claim 10,
wherein the controller controls at least one of the first and second drivers in response to the input information.

12. The observation device according to claim 9, further comprising: a first illuminator, which illuminates the observation target while the controller makes the output signal generator perform the first generation process; and a second illuminator, which illuminates the observation target while the controller makes the output signal generator perform the second generation process.

13. The observation device according to claim 12,
wherein the controller turns off the first illuminator while the output signal generator performs the second generation process, and
wherein the controller turns off the second illuminator while the output signal generator performs the first generation process.

14. The observation device according to claim 12 or 13, further comprising an illumination mirror situated between the first lens mechanism and the observation target,
wherein the second illuminator emits illumination light toward the illumination mirror,
wherein the illumination mirror reflects the illumination light toward the observation target, and
wherein the splitter is situated so that the first area receives the illumination light passing through the observation target.

15. The observation device according to claim 14,
wherein the illumination mirror is situated on the first optical axis to allow passage of the first light propagating along the first optical axis.

16. A signal output method for selectively outputting a first output signal, which represents a first image represented by first light propagating along a first optical axis, and a second output signal, which represents a second image represented by second light propagating along a second optical axis different in direction from the first optical axis, as an output signal, the signal output method comprising a step of:
switching an output of the output signal between the first and second output signals in response to a difference between first optical magnification for the first image and second optical magnification for the second image.

17. A non-transitory computer readable recording medium which stores a signal generation program for causing an output signal generator to selectively generate a first output signal, which represents a first image represented by first light propagating along a first optical axis, and a second output signal, which represents a second image represented by second light propagating along a second optical axis different in direction from the first optical axis, as an output signal,
the signal generation program making the output signal generator execute a step of switching generation of the output signal between the first and second output signals in response to a difference between first optical magnification for the first image and second optical magnification for the second image.
